(19) United States
(12) Patent Application Publication
(10) Pub. No.: US 2024/0324587 A1
(43) Pub. Date: Oct. 3, 2024

(54) LIQUID PROLIPOSOME COMPOSITION OF PLANT PROTECTION AGENTS AND METHOD OF MAKING SAME

(71) Applicant: SYVENTO SP. Z O.O., Skawina (PL)

(72) Inventors: Dominik Lipka, Krakow (PL); Malgorzata Cyza, Krakow (PL); Patrycja Zawilska, Dzierzoniow (PL)

(21) Appl. No.: 18/290,879

(22) PCT Filed: Jul. 22, 2022
(86) PCT No.: PCT/PL2022/050047

§ 371 Date: Jan. 22, 2024

(30) Foreign Application Priority Data
Jul. 22, 2021 (PL) P.438569

(51) Int. Cl. A01N 25/04; A01N 43/40; A01N 43/50; A01N 43/653; A01P 3/00; A01P 13/00

(52) U.S. Cl. CPC A01N 25/04; A01N 43/40; A01N 43/50; A01N 43/653; A01P 3/00; A01P 13/00

(57) ABSTRACT

The invention relates to a liquid proliposome composition of plant protection agents and to a process for the preparation of the composition.

### FIELD OF THE INVENTION

The invention relates to a liquid proliposome composition of plant protection agents and to a process for the preparation of the composition.

### STATE OF THE ART

Growing health and environmental concerns among consumers and the need for chemicals-free products have led to an increase in demand for organic products. Currently, both market and social trends force producers of plant protection products to search for sustainable ecological plant protection products that will not lead to toxic waste in the environment and will be derived from renewable sources. As part of legislative work in the European Union, there is more and more talk about the need to reduce the concentration of plant protection agents of synthetic origin employed or to replace them with substances of natural origin. Unfortunately, such a strategy causes the doses of active substances being used at the limit of their effectiveness, and at the same time in large amounts, the consequence of such action being promotion of the phenomenon of pathogen resistance to a given substance, as well as reduction of the effectiveness of the substance's action.

An effective solution to this problem seems to be the encapsulation of pesticides in a liposome carrier. The liposome carrier is made of a lipid bilayer that allows for the efficient encapsulation of hydrophobic substances. This bilayer surrounds a water core, which can contain hydrophilic substances. Nanocarrier liposomes are currently one of the leading of active substance delivery systems due to their advantages over conventional formulations. They are currently widely used as nanocarriers of active substances in pharmaceutical products, cosmetics and dietary supplements.

Compositions containing liposomes with active substances enclosed therein with a size ranging from 100 nm to 1000 nm allow, among other things, targeted delivery of the active substance with sustained release, improving its stability, reducing its toxicity, increasing its activity (which translates into a reduction in the amount of pesticides used), and improving the penetration through biological barriers such as e.g., the lipid layer of a leaf.

Moreover, liposomes are made of phospholipids, which are 100% biodegradable and compatible with the leaf surface, and thus safe for the environment. Due to their unique vesicle-lipid structure and small size—sizes up to a few μm allowing meandering between the leaf cells, liposomes are able to penetrate into the leaf, so that the active substance is not washed away from the leaf surface, e.g., by rain. This allows the use of a significantly reduced dose of the active substance, which by being gradually released from the liposomes acts on the cells of the fungus attacking the plant for a longer period of time. Such properties of the liposome carrier allow for a significant increase in the effectiveness of the active substance, and may also allow for reduction of the phenomenon of pathogen resistance.

Despite all the advantages of liposomes and numerous research studies on their application, they are not widely used as carriers for plant protection products. The biggest limitations for the use of liposomes in pesticidal compositions include: the problem of their stability resulting from the presence of large amounts of water in liposome compositions, lack of resistance to negative temperatures (transport and storage of the product during the winter), and limitations related to the maximum concentration of the active substance.

Proliposome compositions appear to be the solution to these problems. Proliposomes, i.e., liposome precursors, due to their low water content or absence of water altogether, allow for the encapsulation of both hydrophobic and hydrophilic active substances while maintaining storage stability, and for minimizing the drawbacks resulting from the use of liposomes. The use of proliposomes allows for the preparation of liposomes without loss of the active substance and without changing the physicochemical properties of liposomes formed from them. An additional and equally important advantage of proliposomes is the ease of their preparation and use, as well as the possibility of obtaining a product being a concentrate, which, after dilution, gives a finished product.

Proliposome formulations containing plant protection agents as active ingredients are known in the art.

GB2303791A describes a process for producing a (proliposomal) stock solution which is a pesticide solution and which can be effectively used for liposomal microencapsulation of an agricultural pesticide by mixing this stock solution with water. The method comprises the steps of: a) mixing an organic solvent (capable of dissolving a pesticide) with vegetable lecithin to form a saturated lecithin solution in the solvent in a 1:1 or 1:2 volume ratio; b) allowing the solution to stand to separate the undissolved portion from the solution; c) separating the saturated lecithin solution from the undissolved portion to further use the saturated solution in a subsequent step of blending with the pesticide; and d) mixing the pesticide with a saturated lecithin solution to form a pesticide solution for agricultural use. As already mentioned, before the very use of the solution in agriculture, it is additionally mixed with water to form liposomes. GB2303791A also discloses a pesticidal formulation produced according to the method defined above.

AU1998053619A1, belonging to the same proprietor as GB2303791A, relates to a development of the technology described in GB2303791A, and more specifically to proliposome formulations including boron-containing pesticides, preferably borate, and to a process for the production of such formulations. The process for the production of such a formulation is identical as in GB2303791A.

WO2013171196A1 relates to liposomal compositions providing for control of fungal diseases and microbial infections in food, feed and agricultural products. The disclosure generally relates to conventional liposome formulations, but in one aspect of the invention aqueous and non-aqueous concentrate compositions (stock solutions, proliposome formulations) are disclosed. These concentrates can then be mixed with water to form liposomes. The compositions described in this document contain the active ingredient natamycin, but may advantageously further contain herbicides, fungicides, antibacterial agents, insecticides or nematicides. These compositions may contain natural, semi-synthetic, and synthetic lipids as the lipid responsible for liposome formation. For example, they contain phospholipids, including but not limited to lecithin, and specifically vegetable or animal lecithin, with a purity of less than 95%. Lecithin is present in the composition in an amount of from 0.02 to 2.0 mg/mL.

U.S. Pat. No. 5,004,611A describes a proliposome composition forming a homogeneous mixture of: (a) at least one film-forming lipid (e.g., lecithin) preferably in an amount of 35-55% by weight, (b) at least one non-aqueous liquid consisting of a water-miscible organic liquid, which is a solvent for the lipid (e.g., glycerol, ethanol, propylene glycol, ethanol, isopropanol, ethylene glycol), preferably in an amount of 35-55% by weight, (c) a biologically active agent, the weight ratio of lipid to solvent ranging from 40:1 to 1:20, and sufficient active agent being present to produce a biologically active dose thereof. The composition may also contain from 5 to 40% of water. After adding more water, this mixture spontaneously forms liposomes with a diameter of 0.1 to 2.5 μm, which contain at least 2 mL of encapsulated water phase per gram of lipid. Additional ingredients such as, for example, fatty acid ester and others, may also be present in the composition. The composition may be applied by spray. The main application of the described compositions is pharmaceutical, but U.S. Pat. No. 5,004,611A also mentions the possibility for their use in insect control and in horticulture.

The objective of the present invention was to develop a systemic-action proliposomal composition, which would allow reducing the dose of pesticide used while increasing its uptake into the leaf and maintaining effective herbicidal and fungicidal activity, and which would be characterized by good storage stability and durability.

It has surprisingly been found that all these requirements, and many others, are met by the composition of the present invention.

### Essence of the Invention

The present invention relates to a liquid proliposome composition of plant protection agents containing:
from 1% to 50% by weight of at least one active substance,
from 20% to 75% by weight of at least one lipid,
from 0.1% to 35% by weight of at least one auxiliary substance, including at least one surfactant in an amount of less than 15% by weight,
from 20% to 75% by weight of at least one biodegradable, non-flammable, and non-volatile organic solvent,
from 0 to 12% by weight of water or an aqueous solution of a salt or a buffer substance.

Preferably, the active substance is a herbicide or a fungicide.

Preferably, the at least one active substance constitutes from 5% to 20% by weight of the composition.

Preferably, the ratio of the lipid to the active substance is from 25:1 to 2:1.

Preferably, the lipid comprises from 5% to 99.99% of phosphatidylcholine.

In a particularly preferred embodiment of the invention, the lipid is lecithin.

Preferably the lipid constitutes from 20% to 45% by weight of the composition.

Preferably, the at least one surfactant constitutes 3% by weight based on the weight of the composition.

Preferably the at least one surfactant is selected from the group comprising lysophospholipids, mono- and diglycerides, polysorbates, spans, ethoxylated fatty alcohols, alkoxylated alcohols, ethoxylated fatty acid amines, alkanamines, alkyl sulfates, saponins, alkoxylated phosphate esters, butyl block copolymers, and PEO and PPO block copolymers.

More preferably the at least one surfactant is selected from the group comprising polysorbate 20, a mixture of long-chain (C12-15) fatty alcohols ethoxylated with 3-5 molecules of ethylene oxide, and octylamine.

Preferably, in addition to the at least one surfactant, the composition comprises at least one other auxiliary substance selected from the group comprising antifoaming agents, antioxidants, and biodegradable, non-volatile and non-flammable agents affecting the fluidity of the lipid film.

Preferably, the solvent constitutes from 20% to 30% by weight of the composition.

Preferably the solvent is selected from the group comprising n-butylpyrrolidone, ethylene glycol monobutyl ether, propylene carbonate, N,N-dimethyllactamide, 5-dimethylamino-2-methyl-5-oxovaleric acid methyl ester.

Preferably the composition comprises 8% by weight of water or an aqueous solution of a salt or a buffer substance.

The invention also relates to a process for the preparation of the composition according to the invention, in which, in sequence:
a) the lipid is dissolved in a biodegradable organic solvent and mixed to obtain a mixture,
b) at least one surfactant is added to the mixture resulting from step a) while continuing mixing,
c) at least one active substance is added to the mixture resulting from step b) while continuing mixing,
d) water or an aqueous solution of a salt or buffer substance is optionally added to the mixture resulting from step c),
e) the mixture obtained in step d) is mixed to form a proliposome composition.

### Advantages of the Invention

The research carried out by the inventors showed that
the proliposome compositions according to the invention (compositions according to the invention) show stability even after storage under stress conditions,
the stability of the composition according to the invention after preparation of an aqueous dispersion thereof is independent on the type of water used. The dispersions are stable when using both soft and hard water.
the compositions according to the invention make it possible to obtain very high active substance encapsulation efficiencies.
the compositions according to the invention make it possible to obtain a high penetration performance of the active substance into the leaves.
the fungicide-containing proliposome compositions according to the invention do not cause phytotoxic symptoms.
the fungicide-containing proliposome compositions according to the invention exhibit a comparable or superior fungistatic effect compared to the reference formulations.
the fungicide-containing proliposome compositions according to the invention are effective against a wide range of pathogens, irrespective of the plant species.
the fungicide-containing proliposome compositions according to the invention do not affect or increase the size and the quality of the crop yield (mass of a thousand grains, percent content of protein or oil).

In vitro studies have shown that the proliposome composition obtained according to the invention has all the advantages of liposome compositions, i.e., reduced toxicity, increased permeability, extended residence time of the active substance in the leaf and its prolonged release, which translate into an extended acting duration of this substance, and at the same time it does not have the disadvantages characteristic of the liposomes, such as stability and storage problems. The studies show that the use of such a composition allows to reduce the dose of the pesticide used per ha while maintaining the expected effect, in comparison with the classic compositions of plant protection products. On the basis of field studies it has been shown that in the control of certain pathogens fungicide-containing proliposomal compositions allow the dose of the active substance to be reduced by up to 60%, compared to the reference product, while maintaining efficacy. After mixing the proliposome composition with water to obtain a liposome composition, it was observed that the active substance is encapsulated in the liposomes with an efficiency as high as 98%, which is due to the increased solubility, and it directly influences the increased bioavailability as compared with the free substances. At the same time, the composition of the present invention is not more toxic than the free active substance.

Further in vivo studies have shown that the composition of the present invention exhibits increased leaf penetration when compared with conventional products, for example commercially available products of different composition (see Tables 8 and 9). Increased penetration of plant protection agents into the leaf due to the use of the proliposome composition according to the invention, and additionally due to the use of at least one surfactant in its composition, directly translates into an increased activity of this plant protection agent. In addition to substance penetration into the leaf directly affecting the bioavailability, increased penetration impacts its protection against external factors, such as rain, when it is on the leaf surface.

The composition according to the present invention also contributes to a prolonged release time of the active substance thanks to the use of the proliposome composition according to the invention. This, in turn, directly influences the fungicidal and herbicidal activity of the formulations developed. It is important because of the possibility of secondary fungus infections after fungicide application. In addition, this extended release time allows the use of a lower product concentration thanks to the extended contact time of the fungicide with the fungus.

Thanks to the above-described advantages, the present solution will allow to reduce the amount of pesticides used in agriculture in accordance with the new regulations in conjunction with the Farm2Fork strategy presented by the European Commission. The elaborated composition of plant protection agents allows to reduce the dose of the active substance used and increase the biological effectiveness of the PPA composition. Moreover, thanks to the use of biodegradable solvents and lecithin as the main component of liposome membranes, the proliposomes according to the invention will be an ideal carrier for products based on natural raw materials.

### BRIEF DESCRIPTION OF THE FIGURES OF THE DRAWING

Without restricting the scope of the invention, embodiments are illustrated in the accompanying drawing, in which:

FIG. 1 shows the hydrated proliposome compositions of the invention in an image of cryo-electron microscopy,

FIG. 2 shows the content of difenoconazole in extracts obtained with the use of different solvents.

FIG. 3 shows the percent amount of difenoconazole on the outside and inside of a leaf treated with the dispersion of difenoconazole-containing proliposomes according to the invention.

FIG. 4A shows the effect of various herbicides 23 days after application on the leaves.
A) the herbicide according to the composition of Example 5 at a dose of 25 g of active substance/ha;
B) the herbicide Imazamox 40 SL at a dose of 25 g of active substance/ha;
C) the herbicides Imazamox 40 SL and according to the composition of Example 5 at a dose of 25 g of active substance/ha;
D) the herbicides Imazamox 40 SL and according to the composition of Example 5 at a dose of 36 g of active substance/ha.

### DETAILED DESCRIPTION OF THE INVENTION

The object of the present invention is a liquid proliposome composition dedicated for plant protection agents from the group of systemic-action fungicides and herbicides, and a process for the preparation of such a composition.

### Proliposome Composition

The liquid proliposome composition according to the present invention includes in its composition:
at least one active substance,
at least one lipid forming liposomes,
at least one biodegradable organic solvent,
at least one auxiliary substance, including at least one surfactant,
optionally water or an aqueous solution of a salt or buffer substance.

Such a composition forms a stable and durable water-miscible solution that can be stored and delivered to the site of use. Before use, preferably immediately before use, the composition is mixed with water, and after hydration (water dilution) liposome vesicles with a size of less than 1 μm spontaneously form with a hydrophobic active substance encapsulated therein.

The active substance according to the invention is present in the composition in an amount ranging from about 1% to about 50% by weight, preferably from about 5% to about 45%, 40% or 35% by weight, preferably from about 5% to about 30% or 25% by weight, preferably from about 5% to about 20% by weight, more preferably from about 5 to about 10% by weight, based on the weight of the composition. The active substance can be any systemic-acting fungicide or herbicide. Example fungicides which may constitute active substances according to the present invention: difenoconazole, prothioconazole, metconazole, penthiopyrad, fenpropidin, pyraclostrobin, trifloxystrobin, penconazole, and bupirimate. On the other hand, example herbicides are: fenoxaprop-P-ethyl, florasulam, nicosulfuron, amidosulfuron, iodosulfuron, pirloram, clopyralid, pinoxaden, propaquizafop, benfluralin, prosulfocarb, pethoxamid, clethodim, picolinafen. Preferably, the active substance is difenoconazole, prothioconazole, clopyralid or imazamox. The composition may contain at least one of the above-mentioned active substances, preferably two or more active substances.

The liposome-forming lipid is present in the composition in an amount ranging from about 20% to about 75% by weight, preferably from about 20% to about 45% by weight, more preferably from about 25 to about 40% by weight, based on the weight of the composition. The lipid content of the composition preferably does not exceed 70% by weight, preferably 65% by weight, more preferably 60% by weight or 55 or 50% by weight, and preferably is more than 25% by weight, preferably 30, 35 or 40% by weight. Such lipids may be natural, semi-synthetic and synthetic lipids containing from 5% to 99.99% of phosphatidylcholine, preferably from 20% to 99.9% of phosphatidylcholine, more preferably 20% of phosphatidylcholine. Preferably the liposome-forming lipids are phospholipids, more preferably lecithin, including vegetable or animal lecithin. Even more preferably, the lecithin used in the invention is vegetable lecithin, more preferably it is soy lecithin.

In a preferred embodiment, the composition according to the invention is characterized by a lecithin to active substance ratio of from 25:1 to 2:1, for example such as 20:1, 15:1 or 10:1, and more preferably it is in the range from 6:1 to 2:1.

The at least one solvent according to the invention is used in the composition in an amount of from 20% to 75% by weight, preferably from about 20% to about 30% by weight, preferably from about 20 to about 25% by weight, based on the weight of the composition. The lipid content of the composition preferably does not exceed 70% by weight, preferably 65% by weight, more preferably 60% by weight or 55 or 50% by weight, and preferably is more than 25% by weight, preferably 30, 35 or 40% by weight. The solvents that may be used in accordance with the invention are any biodegradable, water-miscible, non-flammable, non-volatile under storage conditions (ambient temperature) organic solvents. Their amount in the composition is proportional to the amount of lecithin and active substance used, and must be high enough to dissolve both substances. Preferred solvents include: ethers, glycol ethers, lactams, and particularly preferred are: n-butylpyrrolidone, ethylene glycol monobutyl ether, propylene carbonate, N,N-dimethyllactamide, 5-dimethylamino-2-methyl-5-oxovaleric acid methyl ester. More preferably, the solvent is ethylene glycol monobutyl ether. In accordance with the invention, it is possible to use a solvent system which comprises two or more solvents.

The auxiliary substances according to the invention are present in the composition in an amount from about 0.1% to about 35% by weight, preferably from 5 to 30% by weight, more preferably from 10 to 25% by weight, or most preferably 15% by weight, preferably being present from about 20% to about 30% by weight.

Preferably, auxiliary substances that may be included in the compositions of the invention are selected from the group comprising surfactants, antifoaming agents, antioxidants or agents affecting the fluidity of the lipid film. Auxiliary substances serve to increase the stability of the system and to improve the solubility of both the lipid and the active substance. Preferably, the composition comprises more than one auxiliary substance. For example, glycerol is included in the composition as an agent affecting the fluidity of the lipid film.

One of the auxiliary substances is at least one surfactant comprised in the composition in an amount not exceeding 15%, preferably not exceeding 14%, even more preferably not exceeding 13%, for example not exceeding 12%, particularly preferably not exceeding 11%, especially not exceeding 10%, even more preferably not exceeding 9%, especially not exceeding 8%, even more preferably not exceeding 7%, especially not exceeding 6%, particularly preferably from 0.1% to 5% by weight, even more preferably in an amount of about 3% by weight, based on the weight of the composition. Surfactants are compounds whose molecules consist of a lipophilic and a hydrophilic portion. The lipophilic portion of the surfactant may contain one or more fatty acid residues, fatty alcohol residues of varying length and degree of saturation of the hydrocarbon chains, or other hydrophobic residues with high affinity for lipid membranes, e.g., aromatics, and other branched and cyclic alkyl groups. The hydrophilic portion of the surfactant contains hydroxyl groups, carboxyl groups, oxyethylene groups, sugars, carbohydrates, a phosphatidylcholine or phosphatidylethanolamine residue, and derivatives thereof. The presence of surfactants in the composition allows to increase the fluidity of the lipid membrane, which translates into increased penetration of the hydrated liposomes through the leaves. Additionally, the presence of surfactants in the composition allows for more efficient encapsulation of the active substance in hydrated liposomes. The surfactants that can be used according to the invention include in particular: lysophospholipids, mono- and diglycerides, polysorbates, spans, ethoxylated fatty alcohols, alkoxylated alcohols, ethoxylated fatty acid amines, alkanamines, alkyl sulfates, saponins, alkoxylated phosphate esters, butyl block copolymers, PEO and PPO block copolymers. Preferably the surfactant used according to the invention is polysorbate 20, a mixture of long-chain (C12-15) fatty alcohols ethoxylated with 3-5 molecules of ethylene oxide (commercially available under the name ROKAnol DB5), and octylamine. The composition according to the invention may contain one surfactant, preferably it comprises two or more surfactants.

Preferably, the composition of the invention also comprises from 0 to about 12% by weight, more preferably from 5 to 10% by weight, and most preferably about 8% by weight of water or an aqueous solution of a salt, preferably sodium chloride, or a buffering system. The addition of a small amount of water or an aqueous salt solution or buffering system improves the solubility of hydrophilic and amphiphilic substances, such as, e.g., natural lecithin impurities, and reduces the viscosity of the systems.

### Process for the Preparation of a Proliposome Composition

The composition of the present invention can be prepared by substantially any method known in the art that involves mixing the ingredients to achieve the target composition, however, preferably the composition of the invention is prepared as follows:
a) the lipid is dissolved in a biodegradable organic solvent and mixed to obtain a mixture,
b) at least one surfactant is added to the mixture resulting from step a) while continuing mixing,
c) at least one active substance is added to the mixture resulting from step b) while continuing mixing,
d) water or an aqueous solution of a salt or buffer substance is optionally added to the mixture resulting from step c),
e) the mixture obtained in step d) is mixed to form a proliposome composition.

All process steps are preferably carried out in a single device or vessel providing for mixing. The preparation process described above does not require additional steps, which reduces the production time and costs, and additionally does not require the use of specialized equipment (e.g., mills, homogenizers, calibrators, etc.)

Preferably, the process according to the invention is carried out at an increased temperature, preferably in the range from 20° C. to 70° C.

According to the invention, the term “about” as used above and below is to be understood as a deviation of +/−5% from the stated value, reflecting inaccuracies that may arise while carrying out the process for the preparation of the composition according to the invention, e.g., during admeasuring of the ingredients.

### EXAMPLES

### Example 1. Composition According to the Invention

g of ethylene glycol monobutyl ether and 40 g of glycerol were mixed at 60° C. Then, 80 g of soy lecithin (containing 20% phosphatidylcholine) were added, and, after dissolution, 4 g of polysorbate 20 and 2 g of a mixture of long-chain (C12-15) fatty alcohols ethoxylated with 3-5 molecules of ethylene oxide (ROKAnol DB5) were added. 18 g of difenoconazole were added successively while stirring was continued at 60° C. Finally, 16 g of a 5% aqueous NaCl solution were added. After combining, a viscous solution of the substances constituting the composition was obtained.

### Example 2. Composition According to the Invention

28 g of ethylene glycol monobutyl ether and 26 g of glycerol were mixed at 60° C. Then, 26 g of soy lecithin (containing 20% phosphatidylcholine) were added, and, after dissolution, 2 g of polysorbate 20 and 1 g of a mixture of long-chain (C12-15) fatty alcohols ethoxylated with 3-5 molecules of ethylene oxide (ROKAnol DB5) were added. 18 g of difenoconazole were added successively while stirring was continued at 60° C. Finally, 8 g of a 5% aqueous NaCl solution were added. After combining, a viscous solution of the substances constituting the composition was obtained.

### Example 3. Composition According to the Invention

g of ethylene glycol monobutyl ether and 40 g of glycerol were mixed at 60° C. Then, 80 g of soy lecithin (containing 20% phosphatidylcholine) were added, and, after dissolution, 4 g of polysorbate 20 and 2 g of a mixture of long-chain (C12-15) fatty alcohols ethoxylated with 3-5 molecules of ethylene oxide (ROKAnol DB5) were added. 20 g of prothioconazole were added successively while stirring was continued at 60° C. Finally, 16 g of a 5% aqueous NaCl solution were added. After combining, a viscous solution of the substances constituting the composition was obtained.

### Example 4. Composition According to the Invention

42 g of ethylene glycol monobutyl ether and 42 g of glycerol were mixed at 60° C. Then, 84 g of soy lecithin (containing 20% phosphatidylcholine) were added, and, after dissolution, 4 g of polysorbate 20 and 2 g of a mixture of long-chain (C12-15) fatty alcohols ethoxylated with 3-5 molecules of ethylene oxide (ROKAnol DB5) were added. 10 g of clopyralid were added successively while stirring was continued at 60° C. Finally, 16 g of a 5% aqueous NaCl solution were added. After combining, a viscous solution of the substances constituting the composition was obtained. Example 5

### Example 5. Composition According to the Invention

50 g of ethylene glycol monobutyl ether and 50 g of glycerol were mixed at 60° C. Then, 100 g of soy lecithin (containing 20% phosphatidylcholine) were added, and, after dissolution, 5 g of polysorbate 20 and 1.25 g of a mixture of long-chain (C12-15) fatty alcohols ethoxylated with 3-5 molecules of ethylene oxide (ROKAnol DB5) were added. 7 g of octylamine and 16 g of imazamox were added successively while stirring was continued at 60° C. After combining, a viscous solution of the substances constituting the composition was obtained.

### Example 6. Composition According to the Invention

43 g of ethylene glycol monobutyl ether and 43 g of glycerol were mixed at 60° C. Then, 86 g of soy lecithin (containing 20% phosphatidylcholine) were added, and, after dissolution, 4.4 g of polysorbate 20 and 2.2 g of a mixture of long-chain (C12-15) fatty alcohols ethoxylated with 3-5 molecules of ethylene oxide (ROKAnol DB5) were added. 22 g of metconazole were added successively while stirring was continued at 60° C. Finally, 16 g of a 5% aqueous NaCl solution were added. After combining, a viscous solution of the substances constituting the composition was obtained.

### Example 7. Composition According to the Invention

g of ethylene glycol monobutyl ether and 40 g of glycerol were mixed at 60° C. Then, 79 g of soy lecithin (containing 20% phosphatidylcholine) were added, and, after dissolution, 4 g of polysorbate 20 and 2 g of a mixture of long-chain (C12-15) fatty alcohols ethoxylated with 3-5 molecules of ethylene oxide (ROKAnol DB5) were added. 20 g of clopyralid were added successively while stirring was continued at 60° C. Finally, 16 g of a 5% aqueous NaCl solution were added. After combining, a viscous solution of the substances constituting the composition was obtained.

Herein, as proliposomes we refer to liposome precursors which are anhydrous or contain a small amount of water. As liposomes we refer to water-diluted dispersions formed from proliposomes, which spontaneously self-assemble into vesicles constituted by a phospholipid bilayer, closing a water space inside. In the Examples below, when only parameters or properties of the aqueous dispersions are mentioned, reference is made to liposomes. On the other hand, when features, parameters, properties, and effectiveness of both the proliposomes and their aqueous dispersions (liposomes) are summarized, we generally write proliposomes.

### Example 8. Stability Study of the Compositions of Examples 1-5

The stability of the composition according to the invention after dilution with water to obtain liposomes was studied.

TABLE 1
Results of the analysis of proliposomes and their aqueous dispersions.

| INVESTIGATED | | Proliposomes | Proliposomes | Proliposomes | Proliposomes | Proliposomes |
|---|---|---|---|---|---|---|
| PARAMETER | Unit | of Example 1 | of Example 2 | of Example 3 | of Example 4 | of Example 5 |
| Density at | [g/cm³] | 1.1095 | 1.1082 | 1.1187 | 1.111 | 1.091 |
| 20° C. | | | | | | |
| (PA 73 - | | | | | | |
| oscillating tube | | | | | | |
| densitometer | | | | | | |
| method) | | | | | | |
| Content of | [g/L] | 94.1 | 91.4 | 111.4 | 62.8 | 70.5 |
| active | | | | | | |
| (HPLC) | | | | | | |
| pH of 1% | [pH | 6.4 | 6.2 | 6.3 | 3.3 | 6.3 |
| dispersion | unit] | | | | | |
| (MT 75.3) | | | | | | |
| Stability of | [mL] | 0 | 0 | 0 | 0 | 0 |
| 1.0% | | | | | | |
| dispersion | | | | | | |
| after 2 h | | | | | | |
| (CIPAC | | | | | | |
| water A) | | | | | | |
| (MT 36.2) | | | | | | |
| Stability of | [mL] | 0 | 0 | Trace | Trace | 0 |
| 1.0% | | | | sediment | sediment | |
| dispersion | | | | | | |
| after 2 h | | | | | | |
| (CIPAC | | | | | | |
| water D) | | | | | | |
| (MT 36.2) | | | | | | |

The compositions are stable after dilution with water, both soft (CIPAC water A) and hard (CIPAC water D).

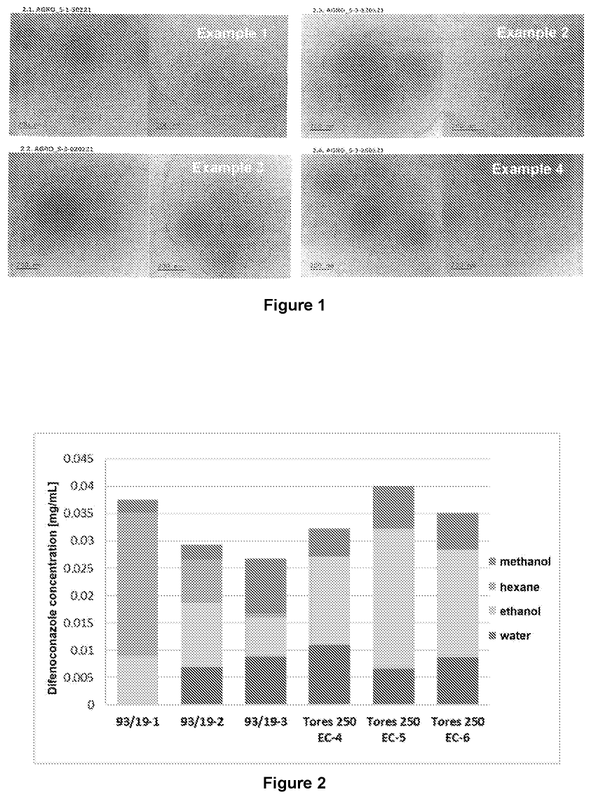

The compositions of Examples 1-5 were also observed for liposome formation. The cryo-electron microscopy image (FIG. 1) shows the presence of liposomes that spontaneously form upon hydration of the proliposome composition. Liposomes up to 1 μm are visible. The composition makes it possible to obtain unilamellar or multilamellar liposomes without the need for an additional sizing step. The absence of crystals/sediment in the field of view proves the high efficiency of encapsulation of the active substance (absence of non-entrapped active substance).

### Example 9. Stability Study of the Compositions of Examples 6-7

The stability of the composition according to the invention after dilution with water to obtain liposomes was studied.

TABLE 2
Results of the analysis of proliposomes
and their aqueous dispersions.

| | | Prolipo- | Prolipo- |
|---|---|---|---|
| | | somes of | somes of |
| INVESTIGATED PARAMETER | Unit | Example 6 | Example 7 |
| GĘSTOŚĆ (MT 3.3) | [g/mL] | 1.0995 | 1.1289 |
| Content of active | [%] | 10.47 | 9.75 |
| (HPLC) | [g/L] | 115.1 | 110.1 |
| pH of 1% (m/v) dispersion in | [pH | 6.8 | 2.7 |
| distilled water (MT 75.3) | unit] | | |
| Stability of 0.5% (v/v) dispersion; | [mL] | oi - 0 | oi - 0 |
| CIPAC water A; 0.5 h (MT 180) | | cr - 0 | cr - 0 |
| | | sed - 0 | sed - 0 |
| Stability of 0.5% (v/v) dispersion; | [mL] | oi - 0 | oi - 0 |
| CIPAC water A; 2 h (MT 180) | | cr - 0 | cr - 0 |
| | | sed - 0 | sed - 0 |
| Stability of 0.5% (v/v) dispersion; | [mL] | oi - 0 | oi - 0 |
| CIPAC water D; 0.5 h (MT 180) | | cr - 0 | cr - 0 |
| | | sed - tr | sed - 0 |
| Stability of 0.5% (v/v) dispersion; | [mL] | oi - 0 | oi - 0 |
| CIPAC water D; 2 h (MT 180) | | cr - 0 | cr - 0 |
| | | sed - tr | sed - 0 |
| Stability of 1.0% (v/v) dispersion; | [mL] | oi - 0 | oi - 0 |
| CIPAC water A; 0.5 h (MT 180) | | cr - 0 | cr - 0 |
| | | sed - 0 | sed - 0 |
| Stability of 1.0% (v/v) dispersion; | [mL] | oi - 0 | oi - 0 |
| CIPAC water A; 2 h (MT 180) | | cr - 0 | cr - 0 |
| | | sed - 0 | sed - 0 |
| Stability of 1.0% (v/v) dispersion; | [mL] | oi - 0 | oi - 0 |
| CIPAC water D; 0.5 h (MT 180) | | cr - 0 | cr - 0 |
| | | sed - 0 | sed - 0 |
| Stability of 1.0% (v/v) dispersion; | [mL] | oi - 0 | oi - 0 |
| CIPAC water D; 2 h (MT 180) | | cr - 0 | cr - 0 |
| | | sed - 0 | sed - 0 |

Key:
oi—oil,
cr—creaming,
sed—sediment;
tr—trace

The compositions are stable after dilution with water, both soft (CIPAC water A) and hard (CIPAC water D), and at different dispersion concentrations.

### Example 10. Accelerated Aging Tests for the Compositions of Example 2 and Example 4

The proliposome compositions were subjected to accelerated aging tests for.
7 days at 0° C.
14 days at 54° C.
56 days at 40° C.

TABLE 3
Results of the analysis of proliposomes with
difenoconazole (Example 2) after aging tests.

| | | | T = 2 | T = 8 |
|---|---|---|---|---|
| INVESTIGATED | | T = 0; | weeks; | weeks; |
| PARAMETER | UNIT | RT | 54° C. | 40° C. |
| DENSITY AT 20° C. | [g/cm³] | 1.1082 | 1.1080 | 1.1080 |
| (OSCILLATING TUBE | | | | |
| DENSITOMETER | | | | |
| METHOD) | | | | |
| DIFENOCONAZOLE | [%] | 8.25 | 8.14 | 8.06 |
| CONTENT | [g/L] | 91.4 | 90.2 | 89.3 |
| (HPLC) | | | | |
| pH, 1% DISPERSION | [pH unit] | 6.5 | 6.2 | 6.2 |
| (MT 75.3) | | | | |
| STABILITY OF 1.0% | [mL] | 0 | 0 | 0 |
| EMULSION AFTER 2 h | | | | |
| (CIPAC WATER A) | | | | |
| (MT 36.2) | | | | |
| STABILITY OF 1.0% | [mL] | 0 | 0 | Traces of |
| EMULSION AFTER 2 h | | | | sediment |
| (CIPAC WATER D) | | | | |
| (MT 36.2) | | | | |

TABLE 4
Results of the analysis of proliposomes with
clopyralid (Example 4) after aging tests.

| | | | T = 2 | T = 8 |
|---|---|---|---|---|
| INVESTIGATED | | T = 0; | weeks; | weeks; |
| PARAMETER | UNIT | RT | 54° C. | 40° C. |
| DENSITY AT 20° C. | [g/cm³] | 1.1110 | 1.1110 | 1.1094 |
| (OSCILLATING TUBE | | | | |
| DENSITOMETER | | | | |
| METHOD) | | | | |
| CLOPYRALID | [%] | 5.65 | 5.63 | 5.63 |
| CONTENT | [g/L] | 62.8 | 62.5 | 61.6 |
| (HPLC) | | | | |
| pH, 1% DISPERSION | [pH unit] | 3.3 | 3.3 | 3.3 |
| (MT 75.3) | | | | |
| STABILITY OF 1.0% | [mL] | 0 | 0 | 0 |
| EMULSION AFTER 2 h | | | | |
| (CIPAC WATER A) | | | | |
| (MT 36.2) | | | | |
| STABILITY OF 1.0% | [mL] | Traces of | Traces of | Traces of |
| EMULSION AFTER 2 h | | sediment | sediment | sediment |
| (CIPAC WATER D) | | | | |
| (MT 36.2) | | | | |

The compositions are stable when stored under stress conditions.

### Example 11. Encapsulation Efficiency of Difenoconazole for the Composition of Example 1

To determine the encapsulation efficiency of the active substance in hydrated liposomes, the non-encapsulated active substance was separated from the liposomes using molecular sieves. The encapsulation efficiency of difenoconazole was measured by HPLC and that of phospholipids-by spectrophotometry. The encapsulation efficiency of the active substance was calculated according to the formula:

$$W = \frac{{A}_{p} / {F}_{p}}{{A}_{t} / {F}_{t}}$$

where:
Aₚ—active substance concentration from measurement [mg/mL]; Fₚ—phospholipids concentration from measurement [mg/mL]; Aₜ—theoretical active substance concentration [mg/mL]; Fₜ—theoretical phospholipid concentration [mg/mL].

TABLE 5
Results - absorbance value, phospholipid and difenoconazole concentration
and encapsulation efficiency for the composition - Example 1.

| | Phospholipids | | | Difenoconazole | | | |
|---|---|---|---|---|---|---|---|
| | concentration | | Phospholipids | concentration | | Difenoconazole | |
| | from | | concentration | from | | concentration | Encapsulation |
| | measurement | | theoretical | measurement | | theoretical | efficiency |
| Absorbance | [mg/mL] | | [mg/mL] | [mg/mL] | | [mg/mL] | [%] |
| 0.133 | 5.13 | 5.13 | 5.02 | 1.05 | 1.05 | 1.05 | 98 |
| 0.127 | 4.90 | | | 1.05 | | | |
| 0.134 | 5.17 | | | 1.04 | | | |
| 0.138 | 5.32 | | | | | | |

The test results showed very high encapsulation efficiencies of difenoconazole (98%) in liposomes after hydration of the proliposome composition of Example 1. High encapsulation efficiencies of the active substance will translate into better penetration of the plant protection agent (PPA) into the leaf, and thus more effective action thereof.

### Example 12. Study of the Penetration of Difenoconazole-Containing Liposomes into the Leaf for the Composition of Example 1

About 5 mL of buffer solution A were introduced into 6 thermostated Franz chambers each (25° C.). An apple leaf was then placed in each of them. 500 μl of difenoconazole-containing liposomes of Example 1 were applied onto the leaves in the first three chambers, and in the next three it was the solution of a commercial formulation Tores 250 EC. Samples (200 μl) were taken from each chamber every 0, 1, 2, 4, 5 and 24 h, replenishing the difference with buffer A.

TABLE 6
Composition of samples subjected to the penetration analysis

| | Difenoconazole | | Solutions for |
|---|---|---|---|
| Sample name | content [g/L] | Dose | analysis |
| Tores 250 EC | 250 | 0.2 L/ha/600 L | 36 mg/100 g |
| | | of water | of water |
| Proliposomes of | 90 | 1.4 L/ha/600 L | 103 mg/100 g |
| Example 1 | | of water | of water |

TABLE 7
Composition of buffer solution A

| Composition: | [g] |
|---|---|
| Water | 469.5 |
| Polysorbate 20 | 5.0 |
| Citric acid | 0.5 |
| Methanol | 25.0 |

Then, the active substance was extracted from the leaves in 4 stages with:
water (washing the leaf surface)
ethanol (extraction of the active substance adsorbed on the leaf surface).
hexane (extraction of the active substance that has penetrated into the cuticle layer)
methanol (extraction of the active substance from the deeper layers of a cut leaf)

5 mL of a given solvent were added to the leaves placed in test tubes at each stage. The whole content was shaken for 60 seconds.

### Results:

TABLE 8
Amount of difenoconazole in individual phases after extraction

| | Liposomes of | Liposomes of | Liposomes of | Tores 250 | Tores 250 | Tores 250 |
|---|---|---|---|---|---|---|
| | Example 1-1 | Example 1-2 | Example 1-3 | EC-4 | EC-5 | EC-6 |
| Water [mg/mL] | 0 | 0.00699 | 0.00884 | 0.01094 | 0.0065 | 0.00878 |
| Methanol [mg/mL] | 0.00247 | 0.00275 | 0.00989 | 0.00513 | 0.00789 | 0.0067 |
| Hexane [mg/mL] | 0.02607 | 0.00795 | 0.00077 | 0 | 0 | 0 |
| Ethanol [mg/mL] | 0.00899 | 0.01172 | 0.00723 | 0.01624 | 0.02575 | 0.01961 |
| Water + ethanol [mg/mL] | 0.00899 | 0.01871 | 0.01607 | 0.02718 | 0.03225 | 0.02839 |
| hexane + methanol [mg/mL] | 0.02854 | 0.0107 | 0.01066 | 0.00513 | 0.00789 | 0.0067 |
| Sum [mg/mL] | 0.0375 | 0.0294 | 0.0267 | 0.0323 | 0.0401 | 0.0351 |
| Water + ethanol [%] | 24.0 | 63.6 | 60.1 | 84.1 | 80.3 | 80.9 |
| Hexane + methanol [%] | 76.0 | 36.4 | 39.9 | 15.9 | 19.7 | 19.1 |

Where:
Water+ethanol−the amount of active substance remaining on the leaf surface.
Hexane+methanol−the amount of active substance that crossed the leaf surface

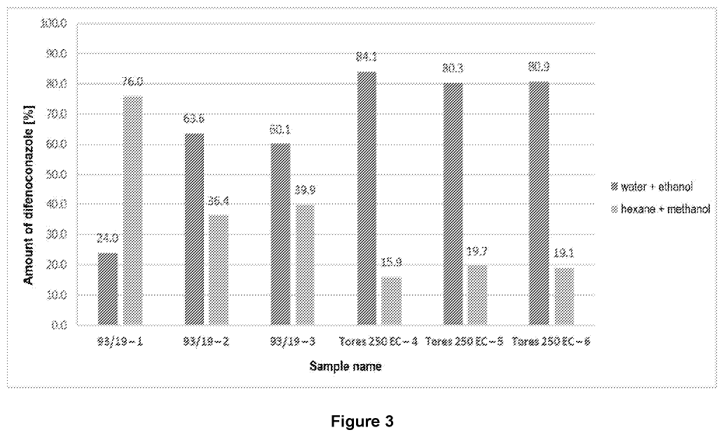

The above results are additionally shown in FIG. 2.

TABLE 9
Amount of difenoconazole permeated to the other side of the leaf

| Time | | Difenoconazole content |
|---|---|---|
| [h] | Sample No. | [mg/mL] |
| 0 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |
| 1 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |
| 2 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |
| 4 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |
| 5 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |
| 24 | Liposomes of Example 1 - 1 | Not detected |
| | Liposomes of Example 1 - 2 | Not detected |
| | Liposomes of Example 1 - 3 | Not detected |
| | Tores 250 EC - 4 | Not detected |
| | Tores 250 EC - 5 | Not detected |
| | Tores 250 EC - 6 | Not detected |

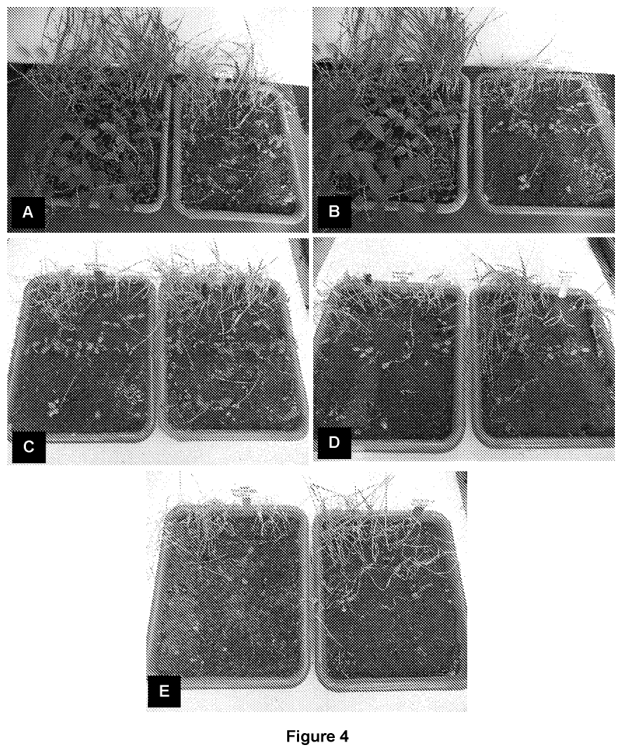

FIG. 3 shows the measurement results of the percent content of difenoconazole on the outside and inside the leaf, with:
Water+ethanol−amount of active substance that remained on the leaf surface.
Hexane+methanol−amount of active substance that crossed the leaf surface.

The obtained results of penetration of difenoconazole into the leaf clearly indicate much more efficient penetration of the active substance enclosed in liposomes compared to the conventional form of this substance available on the market. Such results may indicate a much better penetration of the compositions according to the invention, which may thus translate into a reduction in the concentrations/doses of the plant protection agents used under field conditions.

### Example 13. In Vitro Fungistatic Activity Study for the Composition of Example 1

The study of the fungistatic activity against various strains of pathogenic fungi for plants on the PDA medium under controlled conditions (25° C.) by the method of poisoning the substrates.

Concentration of the active substance in the medium: 200, 20, 5, 2, 1 mg/l.

TABLE 10
Effectiveness of fungistatic action

| | Concentration | Botritis | Fusarium | Sclerotinia | Altrernaria | Rhizoctonia | Phoma | Venturia |
|---|---|---|---|---|---|---|---|---|
| Formulation | of active (mg/L) | cinerea | oxysporu | sclerotioru | alternata | solani | betae | inaequalis |
| Proliposomes of | 200 | 100 | 88.0 | 80.6 | 87.4 | — | 100 | 100 |
| Example 1 95.4 g/L | | | | | | | | |
| Proliposomes of Example 1 | 20 | 100 | 88.0 | 77.4 | 82.0 | — | 100 | 100 |
| (difenoconazole) 95.4 g/L | | | | | | | | |
| Proliposomes of | 5 | 79.0 | 88.0 | 76.0 | 81.4 | 24.0 | 100 | 100 |
| Example 1 95.4 g/L | | | | | | | | |
| Proliposomes of | 2 | 64.6 | — | 61.4 | 76.0 | 20.0 | 94.8 | — |
| Example 1 95.4 g/L | | | | | | | | |
| Proliposomes of | 1 | 63.0 | — | 51.4 | 62.0 | 16.0 | 85.5 | — |
| Example 1 95.4 g/L | | | | | | | | |
| Difenoconazole 250 EC | 200 | 100 | 84.0 | 81.0 | 100 | — | 100 | 100 |
| (Tores 250 EC - standard) | | | | | | | | |
| Difenoconazole 250 EC | 20 | 100 | 84.0 | 80.0 | 96.4 | — | 100 | 100 |
| (Tores 250 EC - standard) | | | | | | | | |
| Difenoconazole 250 EC | 5 | 79.8 | 86.0 | 78.6 | 88.0 | 23.0 | 100 | 100 |
| (Tores 250 EC - standard) | | | | | | | | |
| Difenoconazole 250 EC | 2 | 68.0 | — | 72.0 | 78.0 | 15.0 | 94.8 | — |
| (Tores 250 EC - standard) | | | | | | | | |
| Difenoconazole 250 EC | 1 | 63.0 | — | 57.4 | 62.0 | 12.0 | 85.5 | — |
| (Tores 250 EC - standard) | | | | | | | | |

The results are expressed as % inhibition of linear mycelium growth of a given pathogen species under the action of the formulations as compared with the control combination—fungal colony growing on PDA medium containing a solvent (water).

Results: The proliposome composition of Example 1 showed a fungistatic effect similar to that of the Tores 250 EC standard against the 7 tested pathogenic fungal strains on PDA medium.

### Example 15. Study of the Phytotoxicity of Fungicide Compositions Against Winter Oilseed Rape Under Greenhouse Conditions in Pot Experiments for the Composition of Example 1

TABLE 12
Phytotoxicity of fungicide compositions against winter oilseed rape, Gemini variety

| | | | | Average | | |
|---|---|---|---|---|---|---|
| | | Dose - | | weight of | | |
| | Difenoconazole | formulation | Phytotoxicity | 1 plant | | Reduction |
| | content in | L/ha - g of | (visual assessment) | (5 repeats) | Fresh mass % | of fresh |
| Formulation | formulation g/L | active/ha | Scale 0-4 | mg/plant | of control | mass % |
| Proliposomes | 95.4 | 3.14 | 0.5 | 873.5 | 95.6 | 4.4 |
| of Example 1 | | 300 | growth inhibition | | | |
| Proliposomes | 95.4 | 2.36 | 0 | 892.6 | 97.6 | 3.4 |
| of Example 1 | | 225 | | | | |
| Proliposomes | 95.4 | 1.57 | 0 | 894.3 | 97.8 | 2.2 |
| of Example 1 | | 150 | | | | |
| Tores 250 EC | 250 | 1.2 | 0.5 | 886.8 | 97.0 | 3.0 |
| | | 300 | growth inhibition | | | |
| Tores 250 EC | 250 | 0.9 | 0 | 897.8 | 98.2 | 1.8 |
| | | 225 | | | | |
| Tores 250 EC | 250 | 0.6 | 0 | 920.2 | 100.6 | +0.6 |
| | | 150 | | | | |
| Control | — | — | 0 | 914.1 | | |

* Scale 0-4;
0—no symptoms

Results: To evaluate phytotoxicity, 3 doses were used for each formulation: the lowest and the highest recommended, and doubled taking into account the doses from the label of another commercial agent containing difenoconazole recommended for use with oilseed rape against powdery mildew. The doses for the proliposomes according to Example 1 were calculated based on the active substance content. After 7 days from the treatment, for combination nos. 1 and 4 (the highest doses of both formulations 300 g of active substance/ha, corresponding to 1.2 L/ha of Tores 250EC, which is 2.4 times higher than recommended for winter oilseed rape-0.5 L/ha) a slight inhibition of the growth of rapeseed plants was found (score 0.5 on a scale (0-4)). This translated into a slight decrease of 3-4% in fresh mass 4 weeks after the treatment. There were no other visible symptoms of phytotoxic effect of the formulations against oilseed rape in the 4-week period after application on all objects at lower doses.

### Example 16. Biological Evaluation of the Efficacy of the Fungicide in Proliposome Form of Example 1 in the Control of Sclerotinia sclerotiorum in Winter Oilseed Rape

TABLE 13
Assessment of phytotoxicity

| | | | Phytotoxicity | | |
|---|---|---|---|---|---|
| | | | **DAA | **DAA | **DAA |
| | | | 7 | 21 | 38 |
| | | | BBCH | BBCH | BBCH |
| | Experimental | Dose | 72 | 79-81 | 85 |
| No. | combinations | per ha | % | % | % |
| 1 | Control | — | 0 a | 0 a | 0 a |
| 2 | Tores 250 EC conc. | 1N | 0 a | 0 a | 0 a |
| 3 | Proliposomes according | 1N | 0 a | 0 a | 0 a |
| | to composition 1 | | | | |
| 4 | Proliposomes according | 0.5N | 0 a | 0 a | 0 a |
| | to composition 1 | | | | |
| 5 | Proliposomes according | 0.2N | 0 a | 0 a | 0 a |
| | to composition 1 | | | | |

| | | | |
|---|---|---|---|
| NIR 0.05 | 0.00 | 0.00 | 0.00 |

Control = 0
**DAA—number of days after application

TABLE 14
The percentage of plants in the infested area and the effectiveness
of fungicides in the protection of winter oilseed rape shoots
against Sclerotinia sclerotiorum (SCLESC).

| | | | SCSCL | |
|---|---|---|---|---|
| | | | **DAA 38 | |
| | | | BBCH 83-85 | |
| | Experimental | Dose | (% infested area) | % effec- |
| No. | combinations | per ha | shoots | tiveness* |
| 1 | Control | — | 62.80 a | — |
| 2 | Tores 250 EC conc. | 1N | 49.80 b | 21 |
| 3 | Proliposomes according | 1N | 29.80 c | 53 |
| | to composition 1 | | | |
| 4 | Proliposomes according | 0.5N | 34.20 c | 46 |
| | to composition 1 | | | |
| 5 | Proliposomes according | 0.2N | 54.70 ab | 13 |
| | to composition 1 | | | |

NIR 0.05 6.97
*effectiveness calculated using the Abbott formula
**DAA—number of days after application

TABLE 15
Yield of winter oilseed rape seeds

| | | Dose | Yield* | |
|---|---|---|---|---|
| No. | Experimental combinations | per ha | t/ha | % vs. control |
| 1 | Control | — | 3.63 b | 100 |
| 2 | Tores 250 EC | 1N | 4.35 a | 120 |
| 3 | Proliposomes according to | 1N | 4.43 a | 122 |
| | composition 1 | | | |
| 4 | Proliposomes according to | 0.5N | 4.31 a | 119 |
| | composition 1 | | | |
| 5 | Proliposomes according to | 0.2N | 3.92 b | 108 |
| | composition 1 | | | |

NIR 0.05 0.35
*grain yield was recalculated to 9% humidity

TABLE 16
Mass of a thousand seeds

| | | | Mass of | |
|---|---|---|---|---|
| | | Dose | thousand seeds | |
| No. | Experimental combinations | per ha | g | % vs. control |
| 1 | Control | — | 5.35 c | 100 |
| 2 | Tores 250 EC | 1N | 4.73 ab | 109 |
| 3 | Proliposomes according to | 1N | 4.92 a | 113 |
| | composition 1 | | | |
| 4 | Proliposomes according to | 0.5N | 4.75 ab | 109 |
| | composition 1 | | | |
| 5 | Proliposomes according to | 0.2N | 4.55 bc | 105 |
| | composition 1 | | | |

NIR 0.05 10.25

### Conclusions:

1. No phytotoxic effect of the tested fungicide according to the composition of Example 1 in the doses of 0.2 N, 0.5 N and 1 N, and the comparative agent Tores 250 EC in the dose of 1 N on winter oilseed rape plants, Architect variety, was found.
2. The tested fungicide according to the composition of Example 1 in two higher doses and the comparative agent Tores 250 EC significantly inhibited the development of Sclerotinia sclerotiorum on winter oilseed rape plants.
3. Two higher doses of the tested fungicide according to the composition of Example 1 inhibited the development of Sclerotinia sclerotiorum at the same level. The effectiveness of their action was significantly higher than that of the comparative agent Tores 250 EC, with simultaneous reduction of the dose of the active substance even by a half.
4. The area of winter oilseed rape plants infested by the fungus Sclerotinia sclerotiorum in the experimental combination employing the lowest dose of the tested fungicide was only slightly lower than for the control. However, these differences were not statistically significant.
5. The obtained yields and masses of a thousand grains of winter oilseed rape reflected the level of control of Sclerotinia sclerotiorum. A significant increase in the yield was found using two higher doses of the tested fungicide according to the composition of Example 1 and the comparative agent Tores 250 EC. The highest mass of a thousand seeds was recorded after the application of the highest dose of the tested fungicide according to the composition of Example 1.

### Example 17. Herbicidal Effect of the Herbicides Imazamox 40 SL and the Composition According to Example 5 23 Days after Application on the Leaves (Weed Species: Deaf Oats, Goosegrass, Lamb's Quarters, Rough Pigweed, Charlock, Shepherd's Purse, Self-Seeding Cereals: Barley, Wheat)

A pot experiment on a soil substrate under greenhouse conditions (air temperature during vegetation: 18-28° C.).

Application on the leaves of 18-day-old indicator plants in phase 1-3 of the proper leaf. Evaluation done 7-21 days after application.

TABLE 17
Herbicidal effect of the herbicide in proliposome form compared to Imazamox 40 SL. Evaluation 7 days after application

| | | | | Deaf | | Lamb's | Rough | | Shepherd's | |
|---|---|---|---|---|---|---|---|---|---|---|
| | Dose g | Wheat | Barley | oats | Goosegrass | quarters | pigweed | Charlock | purse | Average |
| Formulation | of act./ha | Weed control, % | | | | | | | | for sp. |
| Proliposomes | 48 | 50 | 55 | 55 | 55 | 55 | 55 | 55 | 70 | 56.25 |
| according to | | | | | | | | | | |
| composition 5 | | | | | | | | | | |
| Proliposomes | 36 | 40 | 40 | 40 | 40 | 40 | 40 | 40 | 55 | 41.88 |
| according to | | | | | | | | | | |
| composition 5 | | | | | | | | | | |
| Proliposomes | 25 | 30 | 30 | 30 | 30 | 30 | 30 | 30 | 40 | 31.25 |
| according to | | | | | | | | | | |
| composition 5 | | | | | | | | | | |
| Imazamox 40 SL | 48 | 55 | 60 | 55 | 55 | 55 | 55 | 55 | 70 | 57.5 |
| Imazamox 40 SL | 36 | 40 | 40 | 40 | 40 | 40 | 40 | 40 | 55 | 41.88 |
| Imazamox 40 SL | 25 | 30 | 30 | 30 | 30 | 30 | 30 | 30 | 40 | 31.25 |
| CONTROL | 0 | 0 | 0 | 0 | 0 | 0 | 0 | 0 | 0 | 0 |

TABLE 17a
Evaluation 15 days after application

| | | | | Deaf | | Lamb's | Rough | | Shepherd's |
|---|---|---|---|---|---|---|---|---|---|
| | Dose g of | Wheat | Barley | oats | Goosegrass | quarters | pigweed | Charlock | purse |
| Formulation | active/ha | Weed control, % | | | | | | | |
| Proliposomes | 48 | 95 | 92 | 90 | 90 | 100 | 100 | 100 | 100 |
| according to | | | | | | | | | |
| composition 5 | | | | | | | | | |
| Proliposomes | 36 | 75 | 66 | 98 | 68 | 100 | 100 | 85 | 100 |
| according to | | | | | | | | | |
| composition 5 | | | | | | | | | |
| Proliposomes | 25 | 58 | 66 | 84 | 67 | 100 | 100 | 52 | 100 |
| according to | | | | | | | | | |
| composition 5 | | | | | | | | | |
| Imazamox 40 SL | 48 | 90 | 100 | 96 | 88 | 100 | 100 | 98 | 100 |
| Imazamox 40 SL | 36 | 92 | 100 | 92 | 70 | 100 | 100 | 82 | 100 |
| Imazamox 40 SL | 25 | 88 | 90 | 88 | 80 | 100 | 100 | 70 | 100 |
| CONTROL | 0 | 0 | 0 | 0 | 0 | 0 | 0 | 0 | 0 |

TABLE 17b
Evaluation 23 days after application

| | | | | Deaf | | Lamb's | Rough | | Shepherd's | Average |
|---|---|---|---|---|---|---|---|---|---|---|
| | Dose g of | Wheat | Barley | oats | Goosegrass | quarters | pigweed | Charlock | purse | for sp. |
| Formulation | act./ha | Weed control, % | | | | | | | | |
| Proliposomes | 48 | 95 | 95 | 95 | 88 | 100 | 100 | 100 | 100 | 96.63 |
| according to | | | | | | | | | | |
| composition 5 | | | | | | | | | | |
| Proliposomes | 36 | 70 | 70 | 80 | 68 | 100 | 100 | 88 | 100 | 84.5 |
| according to | | | | | | | | | | |
| composition 5 | | | | | | | | | | |
| Proliposomes | 25 | 65 | 80 | 70 | 65 | 100 | 100 | 61 | 100 | 80.13 |
| according to | | | | | | | | | | |
| composition 5 | | | | | | | | | | |
| Imazamox 40 SL | 48 | 98 | 100 | 98 | 90 | 100 | 100 | 100 | 100 | 98.25 |
| Imazamox 40 SL | 36 | 95 | 100 | 94 | 70 | 100 | 100 | 98 | 100 | 94.63 |
| Imazamox 40 SL | 25 | 92 | 90 | 95 | 70 | 100 | 100 | 70 | 100 | 89.63 |
| CONTROL | — | 0 | 0 | 0 | 0 | 0 | 0 | 0 | 0 | 0 |

The above effect is also illustrated in FIGS. 4A-E, where:
FIG. 4A shows the effect of the herbicide in proliposome form (Example 5) 23 days after application on the leaves at a dose of 25 g of active substance/ha (control on the left, test sample on the right).
FIG. 4B shows the effect of the herbicide Imazamox 40 SL 23 days after application on the leaves at a dose of 25 g of active substance/ha (control on the left, test sample on the right).
FIG. 4C shows the effect of the herbicides Imazamox 40 SL and the composition of Example 5 23 days after application on the leaves at a dose of 25 g of active substance/ha (Imazamox 40 SL on the left, composition of Example 5 on the right).
FIG. 4D shows the effect of the herbicides Imazamox 40 SL and the composition of Example 5 23 days after application on the leaves at a dose of 36 g of active substance/ha (Imazamox 40 SL on the left, composition of Example 5 on the right).
FIG. 4E shows the effect of the herbicides Imazamox 40 SL and the composition of Example 5 23 days after application on the leaves at a dose of 48 g of active substance/ha (Imazamox 40 SL on the left, composition of Example 5 on the right).

Results: The preliminary results of the study of herbicidal composition of Example 5 indicate a weaker herbicidal effect on self-seeding cereals compared to the Imazamox SL standard at the two lower doses of 36 and 25 g of active substance/ha. After 7 days of application, the activity of both compositions was similar for all test species, differences appeared after 15 days. At the highest dose of 48 g of active substance/ha, no significant differences were found in the action of both herbicides.

TABLE 20
Phytotoxicity of the herbicide composition of Example 5 for the arable plant: soy (varieties:
Aldana, Erica). The dose of the formulation in g of active substance/ha: 36 g (minimum),
48 g (maximum), 96 (doubled). Pot experiment, greenhouse conditions

| | | Content of active | | Dose g of | Phytotoxicity Visual assessment (Scale 0-4) | | | |
|---|---|---|---|---|---|---|---|---|
| No. | Formulation | in formulation | | active/ha | 9 days after appl. | 14 | 21 | 28 |
| 1 | Proliposomes | 70.5 | g/L | 96 | 0.5-1 chlorosis | 0.5 | 0 | 0 |
| | according to | | | | | | | |
| | composition 5 | | | | | | | |
| 2 | Proliposomes | 70.5 | g/L | 48 | 0 | 0 | 0 | |
| | according to | | | | | | | |
| | composition 5 | | | | | | | |
| 3 | Proliposomes | 70.5 | g/L | 36 | 0 | 0 | 0 | 0 |
| | according to | | | | | | | |
| | composition 5 | | | | | | | |
| 4 | Imazamox 40SL | 40 | g/L | 96 | 0.5-1 chlorosis | 0.5 | 0 | 0 |
| 5 | Imazamox 40SL | 40 | g/L | 48 | 0 | 0 | 0 | 0 |
| 6 | Imazamox 40SL | 40 | g/L | 36 | 0 | 0 | 0 | 0 |
| 7 | Control | | | | 0 | 0 | 0 | 0 |

Results: One week after application of both formulations at the highest doses (twice the recommended dose), slight yellowish chlorotic discoloration appeared on the leaves of the soy plants of both varieties, which persisted up to about 15-16 days after application. No other damage was found during the growing season.

TABLE 22
Herbicidal efficacy of the proliposome formulation of Example
5 against the shepherd's purse (Capsella bursa-pastoris)

| | | | | % eradication | | |
|---|---|---|---|---|---|---|
| | Content of | | Dose | Evaluation time, | | |
| | active in | | g of | days after treatment | | |
| Formulation | formulation | | active/ha | 7 | 14 | 21 |
| Proliposomes of | 70.5 | g/L | 48 | 68 | 82 | 94 |
| Example 5 | | | | | | |
| Proliposomes of | 70.5 | g/L | 36 | 57 | 61 | 70 |
| Example 5 | | | | | | |
| Proliposomes of | 70.5 | g/L | 25 | 43 | 52 | 55 |
| Example 5 | | | | | | |
| Imazamox 40 SL | 40 | g/L | 48 | 84 | 97 | 100 |
| Imazamox 40 SL | 40 | g/L | 36 | 66 | 94 | 98 |
| Imazamox 40 SL | 40 | g/L | 25 | 60 | 80 | 82 |

| | | | | | |
|---|---|---|---|---|---|
| Control | — | — | 0 | 0 | 0 |

Results: The herbicidal effect of proliposomes with imazamox at the highest dose after 21 days was comparable to that of Imazamox 40 SL (94 and 100%, respectively), but for the reference product such a result was obtained earlier-after 14 days. At lower doses of 36 and 25 g of active substance/ha, the effect of proliposomes was weaker than that of the standard by about 27%. The maximum herbicidal effect for Imazamox 40 SL at each concentration was obtained after 14 days, while the effect of proliposomes gradually increased over a longer period of time until the 21^{st} day after application.

TABLE 26
Herbicidal efficacy of the preparation according to
composition 5 against spring barley (self-seeding)

| | | | | % eradication | | | |
|---|---|---|---|---|---|---|---|
| | Content of act. | | Dose g of | Evaluation time, days after treatment | | | |
| Formulation | in formulation | | act./ha | 11 | 23 | 30 | 42 |
| Proliposomes | 70.5 | g/L | 48 | 20 | 66 | 84 | 96 |
| according to | | | | | | | |
| composition 5 | | | | | | | |
| Proliposomes | 70.5 | g/L | 36 | 15 | 30 | 40 | 55 |
| according to | | | | | | | |
| composition 5 | | | | | | | |
| Proliposomes | 70.5 | g/L | 25 | 10 | 20 | 25 | 30 |
| according to | | | | | | | |
| composition 5 | | | | | | | |
| Imazamox 40 SL | 40 | g/L | 48 | 30 | 85 | 99 | 100 |
| Imazamox 40 SL | 40 | g/L | 36 | 20 | 65 | 85 | 95 |
| Imazamox 40 SL | 40 | g/L | 25 | 10 | 55 | 65 | 86 |

| | | | | | | |
|---|---|---|---|---|---|---|
| Control | — | — | 0 | 0 | 0 | 0 |

Results: The herbicidal effect of proliposomes at the highest dose against barley after 42 days was good, comparable to that of Imazamox 40 SL (96 and 100%, respectively). The tested herbicide at lower doses exhibited much lower efficacy. At a dose of 36 g/ha, the effectiveness of proliposomes and Imazamox was 55 and 95%, respectively, and at a dose of 25 g/ha, the effectiveness was 30 and 86%.

### Example 19. Phytotoxicity of the Herbicide SNS H 01 19 (Example 5) for Arable Plants—Soy

TABLE 31
Phytotoxicity of the herbicide in proliposome form for the arable
plant - soy, Viola variety. Pot experiments under greenhouse conditions.
Development phase during application: beginning −2 whorls. 5
repeats × 9 plants = 45 plants for 1 combination

| | | | | Phytotoxicity (visual | | |
|---|---|---|---|---|---|---|
| | Content of | | | assessment, scale 0-9)* | | |
| | act. in | | Dose | days after treatment | | |
| Formulation | formulation | | g of act./ha | 7 days | 12 days | 23 days |
| Proliposomes | 70.5 | g/L | 96 | 1 | 0 | 0 |
| according to | | | doubled | chlorosis of | | |
| composition 5 | | | | upper leaves) | | |
| | | | | 10% | | |
| Proliposomes | 70.5 | g/L | 48 | 0.5 | 0 | 0 |
| according to | | | recommended | chlorosis of | | |
| composition 5 | | | | upper leaves | | |
| | | | | 5% | | |
| Proliposomes | 70.5 | g/L | 36 | 0 | 0 | 0 |
| according to | | | recommended | | | |
| composition 5 | | | | | | |
| Imazamox 40 | 40 | g/L | 96 | 1 | 0.5 | |
| SL | | | (doubled) | chlorosis of | chlorosis on | |
| | | | | upper leaves) | young apical | |
| | | | | 10% | leaves. | |
| | | | | | 2. growth | |
| | | | | | inhibition | |
| Imazamox 40 | 40 | g/L | 48 | 0.5 | 0.15 | 0 |
| SL | | | (recommended) | chlorosis of | very slight | |
| | | | | upper leaves | chlorosis on | |
| | | | | 5% | young apical | |
| | | | | | leaves | |
| Imazamox 40 | 40 | g/L | 36 | 0 | 0 | 0 |
| SL | | | (recommended) | | | |

| | | | | | |
|---|---|---|---|---|---|
| Control | — | — | 0 | 0 | 0 |

*scale 0-9 (0 - no phytotoxicity symptoms, 9 - plant destruction)

Results: After 5-7 days from application of both formulations at the highest doses (doubled, 96 g of active substance/ha and 48 g of active substance/ha), slight yellowish chlorotic discoloration appeared on the leaves of Viola soy plants. On the plants sprayed with the composition according to example 5 the discoloration disappeared around day 10-11, while on those sprayed with Imazamox 40 it remained up to about 15-16 days after application, then it disappeared. No other damage was found during the growing season on the remaining objects. Under the influence of Imazamox 40 SL, the growth of soy plants was inhibited from the 12th day (by 14%) to the end of observation-until the 23^{rd} day after application, which was also reflected by a lower mass-a reduction of about 20%.

TABLE 32
The effect of the herbicide in proliposome form on the growth and development of the arable plant - soy, Viola variety. Pot experiments under
greenhouse conditions. Development phase during application: beginning −2 whorls. 5 repeats × 9 plants = 45 plants for 1 combination

| | | | | Plants' height (average) | | | Plants' height (average) | | | Fresh mass of plants | | |
|---|---|---|---|---|---|---|---|---|---|---|---|---|
| | Content | | | 12 days after treatment | | | 23 days after treatment | | | 23 days after treatment | | |
| | of act. in | | Dose g of | | % of | | | % of | | | % of | |
| Formulation | formulation | | act./ha | cm | control | Reduction % | cm | control | Reduction % | g/plant | control | Reduction % |
| Proliposomes | 70.5 | g/L | 96 | 51.1 | 99.4 | 0.6 | 65.5 | 0 | 0 | 2.583 | 96.2 | 3.8 |
| according to | | | | | | | | | | | | |
| composition 5 | | | | | | | | | | | | |
| Proliposomes | 70.5 | g/L | 48 | 52.6 | 102.3 | +2.3 | 66.1 | 100.9 | +0.9 | 2.615 | 97.4 | 2.6 |
| according to | | | | | | | | | | | | |
| composition 5 | | | | | | | | | | | | |
| Proliposomes | 70.5 | g/L | 36 | 54.4 | 105.8 | +5.8 | 68.6 | 104.7 | +4.7 | 2.596 | 96.6 | 3.4 |
| according to | | | | | | | | | | | | |
| composition 5 | | | | | | | | | | | | |
| Imazamox 40 SL | 40 | g/L | 96 | 44.6 | 86.8 | 13.2 | 56.5 | 86.3 | 13.7 | 2.153 | 80.2 | 19.8 |
| Imazamox 40 SL | 40 | g/L | 48 | 47.2 | 91.8 | 8.2 | 64.8 | 98.9 | 1.1 | 2.566 | 95.5 | 4.5 |
| Imazamox 40 SL | 40 | g/L | 36 | 52.2 | 101.6 | +1.6 | 64.3 | 98.2 | 1.8 | 2.612 | 97.2 | 2.8 |

| | | | | | | | | | | | |
|---|---|---|---|---|---|---|---|---|---|---|---|
| Control | — | — | 51.4 | — | — | 65.5 | — | — | 2.686 | — | — |

### Example 20. Biological Evaluation of the Effectiveness of Difenoconazole-Containing Proliposomes (Example 1) in the Control of Powdery Mildew (Blumeria graminis (Ervsiphe graminis)), Brown Rust (Puccinia recondita), Striped Septoriosis of Wheat Leaves (Mycosphaerella graminicola (Anam. Zymoseptoria Tritici) in Winter Wheat, Zyta Variety

TABLE 33
Phytotoxicity

| | | | Phytotoxicity | Phytotoxicity | Phytotoxicity | Phytotoxicity |
|---|---|---|---|---|---|---|
| | | | **DAA 7 (after | **DAA 21 (after | **DAA 8 (after | **DAA 18 (after |
| | | | first treatment) | first treatment) | second treatment) | second treatment) |
| | Experimental | | BBCH 37 | BBCH 45 | BBCH 58-59 | BBCH 69 |
| No. | combinations | Dose | % | % | % | % |
| 1 | Control | — | 0 ac | 0 a | 0 a | 0 a |
| 2 | PROLIPOSOMES | 1N | 0 a | 0 a | 0 a | 0 a |
| | Difenoconazole | | | | | |
| 3 | PROLIPOSOMES | 0.8N | 0 a | 0 a | 0 a | 0 a |
| | Difenoconazole | | | | | |
| 4 | PROLIPOSOMES | 0.6N | 0 a | 0 a | 0 a | 0 a |
| | Difenoconazole | | | | | |
| 5 | PROLIPOSOMES | 0.4N | 0 a | 0 a | 0 a | 0 a |
| | Difenoconazole | | | | | |
| 6 | Dafne 250 EC | 1N | 0 a | 0 a | 0 a | 0 a |

| | | | | |
|---|---|---|---|---|
| NIR 0.05 (LSD 0.05) | . | . | . | . |

control = 0
**DAA—number of days after application

TABLE 34
The average percentage of leaf surface infestation and the
effectiveness of fungicides in the protection of winter wheat
against powdery mildew - Blumeria graminis ERYSGR.

| | | | **DAA 21 | |
|---|---|---|---|---|
| | | | BBCH 45 | |
| | | | | % effec- |
| No. | Experimental combinations | Dose | % L-4 | tiveness* |
| 1 | Control | — | 5.50 a | — |
| 2 | PROLIPOSOMES Difenoconazole | 1N | 0.00 d | 100 |
| 3 | PROLIPOSOMES Difenoconazole | 0.8N | 0.00 d | 100 |
| 4 | PROLIPOSOMES Difenoconazole | 0.6N | 0.50 c | 91 |
| 5 | PROLIPOSOMES Difenoconazole | 0.4N | 1.25 b | 77 |
| 6 | Dafne 250 EC | 1N | 0.00 d | 100 |

| | |
|---|---|
| NIR 0.05 (LSD 0.05) | 0.43 |

*effectiveness calculated using the Abbott formula
**DAA—number of days after application

TABLE 35
The average percentage of leaf surface infestation and the effectiveness of fungicides in the protection
of winter wheat against striped septoriosis of wheat leaves - Zymoseptoria tritici SEPTTR

| | | | | | **DAA 39 | | **DAA 39 | | **DAA 49 | | **DAA 49 | |
|---|---|---|---|---|---|---|---|---|---|---|---|---|
| | | | | | (after first | | (after first | | (after first | | (after first | |
| | | | | | treatment) | | treatment) | | treatment) | | treatment) | |
| | | | **DAA 21 | | **DAA 18 | | **DAA 18 | | **DAA 28 | | **DAA 28 | |
| | | | (after first | | (after second | | (after second | | (after second | | (after second | |
| | | | treatment) | | treatment) | | treatment) | | treatment) | | treatment) | |
| | | | BBCH 45 | | BBCH 69 | | BBCH 69 | | BBCH 75-77 | | BBCH 75-77 | |
| | | | % | | % | | % | | % | | % | |
| | | | surface | | surface | | surface | | surface | | surface | |
| | | | infest- | % | infest- | % | infest- | % | infest- | % | infest- | % |
| | Experimental | | ation | effec- | ation | effec- | ation | effec- | ation | effec- | ation | effec- |
| No. | combinations | Dose | of L-4 | tiveness* | of L-3 | tiveness* | of L-2 | tiveness* | of L-2 | tiveness* | of L-1 | tiveness* |
| 1 | Control | — | 7.38 a | — | 14.94 a | — | 5.06 a | — | 35.31 a | — | 13.00 a | — |
| 2 | PROLIPOSOMES | 1N | 3.56 b | 52 | 5.94 d | 60 | 0.00 d | 100 | 18.44 d | 48 | 5.31 d | 59 |
| | Difenoconazole | | | | | | | | | | | |
| 3 | PROLIPOSOMES | 0.8N | 4.81 b | 35 | 6.81 cd | 54 | 0.75 cd | 85 | 19.06 d | 46 | 7.38 bcd | 43 |
| | Difenoconazole | | | | | | | | | | | |
| 4 | PROLIPOSOMES | 0.6N | 4.94 b | 33 | 7.31 bc | 51 | 1.25 bc | 75 | 23.13 bc | 35 | 8.19 bc | 37 |
| | Difenoconazole | | | | | | | | | | | |
| 5 | PROLIPOSOMES | 0.4N | 6.81 a | 8 | 8.19 b | 45 | 1.94 b | 62 | 25.38 b | 28 | 9.75 b | 25 |
| | Difenoconazole | | | | | | | | | | | |
| 6 | Dafne 250 EC | 1N | 4.75 b | 36 | 6.63 cd | 56 | 1.38 bc | 73 | 21.13 cd | 40 | 6.31 cd | 51 |

| | | | | | |
|---|---|---|---|---|---|
| NIR 0.05 (LSD 0.05) | 1.40 | 1.27 | 1.03 | 2.78 | 2.39 |

*effectiveness calculated using the Abbott formula
**DAA—number of days after application

TABLE 36
The average percentage of leaf surface infestation and the effectiveness of fungicides
in the protection of winter wheat against brown rust - Puccinia recondita PUCCRE.

| | | | **DAA 49 (after first treatment) | | **DAA 49 (after first treatment) | |
|---|---|---|---|---|---|---|
| | | | **DAA 28 (after second treatment) | | **DAA 28 (after second treatment) | |
| | | | BBCH 75-77 | | BBCH 75-77 | |
| | Experimental | | % surface | % | % surface | % |
| No. | combinations | Dose | infestation of L-2 | effectiveness* | infestation of L-1 | effectiveness* |
| 1 | Control | — | 5.00 a | — | 8.63 a | — |
| 2 | PROLIPOSOMES | 1N | 0.00 c | 100 | 0.00 c | 100 |
| | Difenoconazole | | | | | |
| 3 | PROLIPOSOMES | 0.8N | 0.00 c | 100 | 0.63 c | 93 |
| | Difenoconazole | | | | | |
| 4 | PROLIPOSOMES | 0.6N | 0.00 c | 100 | 0.88 bc | 90 |
| | Difenoconazole | | | | | |
| 5 | PROLIPOSOMES | 0.4N | 1.81 b | 64 | 1.88 b | 78 |
| | Difenoconazole | | | | | |
| 6 | Dafne 250 EC | 1N | 0.00 c | 100 | 0.00 c | 100 |

| | | |
|---|---|---|
| NIR 0.05 (LSD 0.05) | 0.49 | 1.01 |

*effectiveness calculated using the Abbott formula
**DAA—number of days after application

TABLE 37
Preserved green area of winter wheat

| | | | **DAA 49 (after |
|---|---|---|---|
| | | | first treatment) |
| | | | **DAA 28 (after |
| | | | second treatment) |
| | | | BBCH 75-77 |
| | Experimental | | % |
| No. | combinations | Dose | L-2, L-1 |
| 1 | Control | — | 31.25 b |
| 2 | PROLIPOSOMES | 1 N | 50.00 a |
| | Difenoconazole | | |
| 3 | PROLIPOSOMES | 0.8 N | 47.50 a |
| | Difenoconazole | | |
| 4 | PROLIPOSOMES | 0.6 N | 37.50 b |
| | Difenoconazole | | |
| 5 | PROLIPOSOMES | 0.4 N | 35.00 b |
| | Difenoconazole | | |
| 6 | Dafne 250 EC | 1 N | 50.00 a |

| | |
|---|---|
| NIR 0.05 (LSD 0.05) | 8.91 |

TABLE 38
Fresh mass content, grain yield, mass of a thousand grains, protein content - of winter wheat

| | | | Fresh mass content | | Yield* | | Mass of thousand grains | | Protein % of dry mass | |
|---|---|---|---|---|---|---|---|---|---|---|
| | Experimental | | | % vs. | | % vs. | | % vs. | % of | % vs. |
| No. | combinations | Dose | kg | control | t/ha | control | g | control | dry mass | control |
| 1 | Control | — | 10.21 a | 100 | 6.8 a | 100 | 42.20 a | 100 | 10.09 a | 100 |
| 2 | PROLIPOSOMES | 1N | 10.34 a | 101 | 6.95 a | 101 | 42.15 a | 100 | 10.09 a | 100 |
| | Difenoconazole | | | | | | | | | |
| 3 | PROLIPOSOMES | 0.8N | 10.68 a | 105 | 7.18 a | 105 | 42.40 a | 100 | 10.36 a | 103 |
| | Difenoconazole | | | | | | | | | |
| 4 | PROLIPOSOMES | 0.6N | 10.56 a | 103 | 7.15 a | 104 | 42.31 a | 100 | 9.85 a | 98 |
| | Difenoconazole | | | | | | | | | |
| 5 | PROLIPOSOMES | 0.4N | 10.69 a | 105 | 7.22 a | 105 | 42.50 a | 101 | 10.05 a | 100 |
| | Difenoconazole | | | | | | | | | |
| 6 | Dafne 250 EC | 1N | 10.50 a | 103 | 7.10 a | 103 | 42.50 a | 101 | 10.38 a | 103 |

| | | | | |
|---|---|---|---|---|
| NIR 0.05 (LSD 0.05) | 0.89 | 0.60 | 0.73 | 0.74 |

*grain yield was recalculated to 15% humidity

### Results:

During the first application performed in the development phase of the BBCH 32-33 arable plant, symptoms of infestation by the fungus Zymoseptoria tritici, which is the cause of striped septoriosis of wheat leaves, were observed on the lower leaves of winter wheat, Zyta variety, at a level of 10% leaf infested area. On the other hand, infestation by Blumeria graminis—the cause of powdery mildew—was at a level of 3%. Three weeks after the first application, a second treatment was performed in the development phase BBCH 45 of the arable plant; at that time the plants were observed to be infested on the L-4 leaf by Zymoseptoria tritici and by Blumeria graminis. The infestation in the small control fields (hereinafter also referred to as the control) was on average 7.38% and 5.5%, respectively. The effectiveness of the tested fungicides three weeks after the first application was 77-100% in the case of powdery mildew, while in the case of striped septoriosis of wheat leaves it was at a level of 8-52% (Table 34, Table 35).

Approximately three weeks after the second application, striped septoriosis was observed on the upper leaves in an intensity of about 15% on the L-3 leaf and about 5% on the L-2 leaf in the small control fields. The effectiveness of the tested fungicides was: 45-60% on the L-3 leaf and 62-100% on the L-2 leaf. The comparative agent inhibited disease development by 56% on the L-3 leaf and by 73% on the L-2 leaf (Table 35).

During the evaluation performed in the development phase BBCH 75-77 of winter wheat, Zyta variety, the occurrence of diseases such as striped septoriosis of leaves and brown rust on the L-2 subflag leaf and on the L-1 flag leaf were observed at a level of 35.31% and 13% in the case of Zymoseptoria tritici, and 5% and 8.63% in the case of Puccinia recondita, respectively. The effectiveness of the tested composition of Example 1 ranged from 25-59% for striped septoriosis of wheat leaves and 64-100% for brown rust. On the other hand, the comparative agent Daphne 250 EC inhibited the development of striped septoriosis of leaves on the L-2 leaf by 40% and on the L-1 leaf by 51%, while the development of brown rust was inhibited 100% on both the L-2 and L-1 leaves (Table 35, Table 36).

In the development phase BBCH 75 of the plants, the green area of the subflag L-2 and flag L-1 leaves was higher for all tested combinations compared with the control (Table 37).

Grain yield, mass of a thousand grains, and percent content of protein were on the same level for all tested experimental combinations (Table 38).

### Conclusions:

1. In the experiment conducted, no symptoms of phytotoxic action of the fungicide in proliposome form in various doses and of the standard agent Dafne 250 EC on winter wheat plants of the Zyta variety were found.
2. The tested proliposomes applied in the doses of 0.8 N and 1 N showed 100% effectiveness in reducing the occurrence of Blumeria graminis on the L-4 leaf, being on the level of the comparative agent Dafne 250 EC (1 N).
3. The investigated fungicide in proliposome form in the doses of 0.8 N and 1 N applied against Zymoseptoria tritici performed better than the comparative agent Dafne 250 EC.
4. The tested proliposomes used in the doses of 0.6 N, 0.8 N and 1 N showed 100% effectiveness in reducing the occurrence of Puccinia recondita on the L-2 leaf, being on the level of the comparative agent Dafne 250 EC (1 N).
5. An increase in green leaf area (GLA) was observed after application of the studied proliposomal agent at all doses tested and of the comparative agent Dafne 250 EC, as compared with the control.
6. The use of proliposomes and Dafne 250 EC, regardless of the dose employed, did not affect the size and the quality (mass of a thousand grains, percent content of protein) of the yield of winter wheat, Zyta variety.

### Example 21. Biological Evaluation of the Efficacy of Difenoconazole-Containing Proliposomes (Example 1) in Controlling Powdery Mildew (Blumeria graminis (Erysiphe graminis)), Striped Septoriosis of Wheat Leaves (Mycosphaerella graminicola (Anam. Zymoseptoria Tritici) in Winter Wheat, Arkadia Variety

TABLE 39
Phytotoxicity.

| | | | | | Phytotoxicity | Phytotoxicity |
|---|---|---|---|---|---|---|
| | | | | | **DAA 29 (after | **DAA A 36 (after |
| | | | Phytotoxicity | Phytotoxicity | first treatment) | first treatment) |
| | | | **DAA 7 (after | **DAA 21 (after | **DAA 8 (after | **DAA 15 (after |
| | | | first treatment) | first treatment) | second treatment) | second treatment) |
| | Experimental | | BBCH 37-39 | BBCH 49-53 | BBCH 59-61 | BBCH 69 |
| No. | combinations | Dose | % | % | % | % |
| 1 | Control | — | 0 a | 0 a | 0 a | 0 a |
| 2 | PROLIPOSOMES | 1N | 0 a | 0 a | 0 a | 0 a |
| | Difenoconazole | | | | | |
| 3 | PROLIPOSOMES | 0.8N | 0 a | 0 a | 0 a | 0 a |
| | Difenoconazole | | | | | |
| 4 | PROLIPOSOMES | 0.6N | 0 a | 0 a | 0 a | 0 a |
| | Difenoconazole | | | | | |
| 5 | PROLIPOSOMES | 0.4N | 0 a | 0 a | 0 a | 0 a |
| | Difenoconazole | | | | | |
| 6 | Dafne 250 EC | 1N | 0 a | 0 a | 0 a | 0 a |

| | | | | |
|---|---|---|---|---|
| NIR 0.05 (LSD 0.05) | . | . | . | . |

control = 0
**DAA—number of days after application

TABLE 40
The average percentage of leaf surface infestation and the effectiveness of fungicides
in the protection of winter wheat against powdery mildew - Blumeria graminis ERYSGR.

| | | | | | **DAA 36 (after first application) | |
|---|---|---|---|---|---|---|
| | | | **DAA 21 (after first application) | | **DAA 15 (after second application) | |
| | | | BBCH 49-53 | | BBCH 69 | |
| | | | % surface | | % surface | |
| | Experimental | | infestation | % | infestation | % |
| No. | combinations | Dose | of L-4 | effectiveness* | of L-2 | effectiveness* |
| 1 | Control | — | 7.81 a | — | 5.31 a | — |
| 2 | PROLIPOSOMES | 1N | 0.50 c | 94 | 0.00 d | 100 |
| | Difenoconazole | | | | | |
| 3 | PROLIPOSOMES | 0.8N | 2.44 b | 69 | 0.56 cd | 89 |
| | Difenoconazole | | | | | |
| 4 | PROLIPOSOMES | 0.6N | 2.63 b | 66 | 1.44 c | 73 |
| | Difenoconazole | | | | | |
| 5 | PROLIPOSOMES | 0.4N | 3.44 b | 56 | 2.44 b | 54 |
| | Difenoconazole | | | | | |
| 6 | Dafne 250 EC | 1N | 1.63 bc | 79 | 0.00 d | 100 |

| | | |
|---|---|---|
| NIR 0.05 (LSD 0.05) | 1.79 | 0.96 |

*“effectiveness calculated using Abbott's formula”
**DAA—number of days after application

TABLE 41
The average percentage of leaf surface infestation and the effectiveness of fungicides in the protection
of winter wheat against striped septoriosis of wheat leaves - Zymoseptoria tritici SEPTTR.

| | | | | | **DAA 36 (after | | **DAA 49 (after | | **DAA 49 (after | |
|---|---|---|---|---|---|---|---|---|---|---|
| | | | | | first treatment) | | first treatment) | | first treatment) | |
| | | | **DAA 21 (after | | **DAA 15 (after | | **DAA 28 (after | | **DAA 28 (after | |
| | | | first treatment) | | second treatment) | | second treatment) | | second treatment) | |
| | | | BBCH 49-53 | | BBCH 69 | | BBCH 69 | | BBCH 75-77 | |
| | | | % surface | % | % surface | % | % surface | % | % surface | % |
| | Experimental | | infestation | effec- | infestation | effec- | infestation | effec- | infestation | effec- |
| No. | combinations | Dose | of L-4 | tiveness* | of L-2 | tiveness* | of L-1 | tiveness* | of L-1 | tiveness* |
| 1 | Control | — | 6.38 a | — | 20.94 a | — | 5.38 a | — | 21.38 a | — |
| 2 | PROLIPOSOMES | 1N | 2.75 b | 57 | 9.00 c | 57 | 2.06 b | 62 | 6.88 c | 68 |
| | Difenoconazole | | | | | | | | | |
| 3 | PROLIPOSOMES | 0.8N | 3.81 b | 40 | 11.19 bc | 47 | 2.50 b | 53 | 8.56 bc | 60 |
| | Difenoconazole | | | | | | | | | |
| 4 | PROLIPOSOMES | 0.6N | 4.25 b | 33 | 12.69 b | 39 | 2.81 b | 48 | 10.19 b | 52 |
| | Difenoconazole | | | | | | | | | |
| 5 | PROLIPOSOMES | 0.4N | 5.75 a | 10 | 13.38 b | 36 | 3.25 b | 40 | 10.94 b | 49 |
| | Difenoconazole | | | | | | | | | |
| 6 | Dafne 250 EC | 1N | 3.25 b | 49 | 14.19 b | 32 | b | 50 | 8.06 bc | 62 |

| | | | | |
|---|---|---|---|---|
| NIR 0.05 (LSD 0.05) | 1.40 | 2.99 | 1.33 | 2.90 |

*effectiveness calculated using the Abbott formula
**DAA - number of days after application

TABLE 42
Preserved green area of winter wheat.

| | | | **DAA 49 (after |
|---|---|---|---|
| | | | first treatment) |
| | | | **DAA 28 (after |
| | | | secondtreatment) |
| | | | BBCH 75-77 |
| No. | Experimental combinations | Dose | % |
| 1 | Control | — | 10.00 d |
| 2 | PROLIPOSOMES Difenoconazole | 1N | 25.00 ab |
| 3 | PROLIPOSOMES Difenoconazole | 0.8N | 23.75 abc |
| 4 | PROLIPOSOMES Difenoconazole | 0.6N | 22.50 bc |
| 5 | PROLIPOSOMES Difenoconazole | 0.4N | 21.25 c |
| 6 | Dafne 250 EC | 1N | 26.25 a |

| | |
|---|---|
| NIR 0.05 (LSD 0.05) | 3.25 |

**DAA—number of days after application

TABLE 43
Fresh mass content, grain yield, mass of a thousand grains, protein content - of winter wheat.

| | | | | | | | | | Protein % of dry | |
|---|---|---|---|---|---|---|---|---|---|---|
| | | | Fresh mass | | | | Mass of thousand | | mass | |
| | | | content | | Yield* | | grains | | % of | |
| | Experimental | | | % vs. | | % vs. | | % vs. | dry | % vs. |
| No. | combinations | Dose | kg | control | t/ha | control | g | control | mass | control |
| 1 | Control | — | 7.13 a | 100 | 4.81 a | 100 | 37.81 a | 100 | 10.98 | 100 |
| 2 | PROLIPOSOMES | 1N | 7.14 a | 100 | 4.84 a | 101 | 37.86 a | 100 | 10.62 | 97 |
| | Difenoconazole | | | | | | | | | |
| 3 | PROLIPOSOMES | 0.8N | 7.91 a | 111 | 5.34 a | 111 | 38.40 a | 102 | 10.84 | 99 |
| | Difenoconazole | | | | | | | | | |
| 4 | PROLIPOSOMES | 0.6N | 7.65 a | 107 | 5.17 a | 108 | 39.74 a | 105 | 10.49 | 96 |
| | Difenoconazole | | | | | | | | | |
| 5 | PROLIPOSOMES | 0.4N | 7.75 a | 109 | 5.23 a | 109 | 39.01 a | 103 | 10.53 | 96 |
| | Difenoconazole | | | | | | | | | |
| 6 | Dafne 250 EC | 1N | 7.13 a | 96 | 4.62 a | 96 | 37.88 a | 100 | 10.85 | 99 |

| | | | | |
|---|---|---|---|---|
| NIR 0.05 (LSD 0.05) | 1.94 | 1.31 | 2.40 | 1.10 |

*grain yield was recalculated to 15% humidity

### Results:

During the first application performed in the development phase BBCH 32-33 of the arable plant, symptoms of infestation by the fungus Zymoseptoria tritici, which is the cause of striped septoriosis of wheat leaves, were observed on the lower leaves of winter wheat, Arkadia variety, at a level of 15% leaf infested area. On the other hand, infestation by Blumeria graminis—the cause of powdery mildew—was at a level of 4%. Three weeks after the first application, a second treatment was performed in the development phase BBCH 49-53 of the arable plant; at that time the infestation of the plants in the small control fields on the L-4 leaf by Zymoseptoria tritici was on the order of 6.38%, and the infestation of the plants in the small control fields on the L-4 leaf by Blumeria graminis was on the order of 7.81%. The effectiveness of the tested fungicides three weeks after the first application was at a level of 56-94% on L-4 in the case of powdery mildew, while in the case of striped septoriosis of wheat leaves it was at a level of 10-57% (Table 40, Table 41).

Approximately two weeks after the second application, powdery mildew was observed on the upper leaves in an intensity of about 5% on L-2 in the small control fields. The effectiveness of the tested fungicide, depending on the dose employed, was 54-100% on the L-2 leaf. The comparative agent inhibited disease 100% on the L-2 leaf. On the other hand, striped septoriosis of leaves occurred at an intensity of approximately 21% on the L-2 leaf and approximately 5% on the L-1 leaf in the small control fields. The effectiveness of the tested fungicide, depending on the dose employed, was 36-57% on the L-2 leaf, whereas it was 40-62% on the L-1 leaf. The comparative agent inhibited disease development by 32% on the L-2 leaf and by 50% on the L-1 leaf (Table 40, Table 41).

During the evaluation performed in the development phase BBCH 75-77 of winter wheat, Arkadia variety, the occurrence of striped septoriosis of leaves on the L-1 flag leaf was 21.38%. The efficacy of the test composition of Example 1 ranged from 49 to 68% on L-1 (Table 41).

In the development phase BBCH 75-77 of the plants, the green area of the L-1 flag leaf was higher for all tested combinations compared with the control (Table 42).

### Conclusions:

1. In the experiment conducted, no phytotoxic effects of the fungicide in proliposome form in various doses and of the standard agent Dafne 250 EC on winter wheat plants, Arkadia variety, were found.
2. The effectiveness of the proliposome formulation against Blumeria graminis comparable to the standard agent was demonstrated for the 1 N dose.
3. The tested proliposomes applied twice in doses of 0.8 N and 1 N reduced the occurrence of Zymoseptoria tritici on the level of the standard agent Dafne 250 EC.
4. A significant increase in green leaf area (GLA) was observed after application of the studied proliposome agent at all doses tested and of the comparative agent Dafne 250 EC, as compared with the control.
4. In the small fields treated with proliposomes, irrespective of the dose employed, an average significant increase in the yield and an increase in the mass of a thousand seeds was observed, as compared with the small control fields.

### Example 22. Biological Evaluation of the Efficacy of Difenoconazole-Containing Proliposomes (Example 1) in the Control of Powdery Mildew (Blumeria graminis (Erysiphe graminis)), Brown Rust (Puccinia recondita), Yellow Leaf Blotch (Pyrenophora tritici-Repentis), Striped Septoriosis of Wheat Leaves (Mycosphaerella graminicola (Anam. Zymoseptoria Tritici) in Winter Wheat of the Tobak Variety

TABLE 44
Phytotoxicity.

| | | | | | Phytotoxicity | Phytotoxicity |
|---|---|---|---|---|---|---|
| | | | | | **DAA 29 (after | **DAA A 36 (after |
| | | | Phytotoxicity | Phytotoxicity | first treatment) | first treatment) |
| | | | **DAA 7 (after | **DAA 14 (after | **DAA 8 (after | **DAA 15 (after |
| | | | first treatment) | first treatment) | second treatment) | second treatment) |
| | Experimental | | BBCH 37 | BBCH 45-47 | BBCH 59 | BBCH 61 |
| No. | combinations | Dose | % | % | % | % |
| 1 | Control | — | 0 a | 0 a | 0 a | 0 a |
| 2 | PROLIPOSOMES | 1N | 0 a | 0 a | 0 a | 0 a |
| | Difenoconazole | | | | | |
| 3 | PROLIPOSOMES | 0.8N | 0 a | 0 a | 0 a | 0 a |
| | Difenoconazole | | | | | |
| 4 | PROLIPOSOMES | 0.6N | 0 a | 0 a | 0 a | 0 a |
| | Difenoconazole | | | | | |
| 5 | PROLIPOSOMES | 0.4N | 0 a | 0 a | 0 a | 0 a |
| | Difenoconazole | | | | | |
| 6 | Dafne 250 EC | 1N | 0 a | 0 a | 0 a | 0 a |

| | | | | |
|---|---|---|---|---|
| NIR 0.05 (LSD 0.05) | . | . | . | . |

control = 0
**DAA - number of days after application

TABLE 45
The average percentage of leaf surface infestation and the effectiveness of fungicides
in the protection of winter wheat against powdery mildew - Blumeria graminis ERYSGR.

| | | | | | | | **DAA A 36 (after | | **DAA A 36 (after | |
|---|---|---|---|---|---|---|---|---|---|---|
| | | | | | | | first treatment) | | first treatment) | |
| | | | | | | | **DAA 15 (after | | **DAA 15 (after | |
| | | | **DAA 21 (after | | **DAA 21 (after | | second | | second | |
| | | | first treatment) | | first treatment) | | treatment) | | treatment) | |
| | | | BBCH 45-47 | | BBCH 45-47 | | BBCH 61 | | BBCH 61 | |
| | | | % | | % | | % | | % | |
| | | | surface | | surface | | surface | | surface | |
| | | | infestation | % | infestation | % | infestation | % | infestation | % |
| | Experimental | | of | effec- | of | effec- | of | effec- | of | effec- |
| No. | combinations | Dose | L-4 | tiveness* | L-3 | tiveness* | L-3 | tiveness* | L-2 | tiveness* |
| 1 | Control | — | 14.00 a | — | 5.13 a | — | 21.56 a | — | 6.75 a | — |
| 2 | PROLIPOSOMES | 1N | 1.56 d | 89 | 0.38 b | 93 | 4.50 d | 79 | 0.81 b | 88 |
| | Difenoconazole | | | | | | | | | |
| 3 | PROLIPOSOMES | 0.8N | 2.69 d | 81 | 0.44 b | 91 | 7.19 cd | 67 | 1.44 b | 79 |
| | Difenoconazole | | | | | | | | | |
| 4 | PROLIPOSOMES | 0.6N | 5.44 bc | 61 | 0.56 b | 88 | 10.75 b | 50 | 2.00 b | 70 |
| | Difenoconazole | | | | | | | | | |
| 5 | PROLIPOSOMES | 0.4N | 6.06 b | 57 | 0.75 b | 85 | 11.38 b | 47 | 2.56 b | 62 |
| | Difenoconazole | | | | | | | | | |
| 6 | Dafne 250 EC | 1 N | 3.38 cd | 76 | 1.44 b | 72 | 7.56 c | 65 | 1.50 b | 78 |

| | | | | |
|---|---|---|---|---|
| NIR 0.05 (LSD 0.05) | 2.07 | 1.51 | 2.79 | 1.79 |

*effectiveness calculated using the Abbott formula
**DAA - number of days after application

TABLE 46a
The average percentage of leaf surface infestation and the effectiveness of fungicides in the protection
of winter wheat against striped septoriosis of wheat leaves - Zymoseptoria tritici SEPTTR.

| | | | | | **DAA A 36 (after first | | **DAA A 36 (after first | |
|---|---|---|---|---|---|---|---|---|
| | | | | | treatment) | | treatment) | |
| | | | **DAA 21 (after first | | **DAA 15 (after second | | **DAA 15 (after second | |
| | | | treatment) | | treatment) | | treatment) | |
| | | | BBCH 45-47 | | BBCH 61 | | BBCH 61 | |
| | | | % surface | | % surface | | % surface | |
| | Experimental | | infestation of | % | infestation of | % | infestation of | % |
| No. | combinations | Dose | L-4 | effectiveness* | L-3 | effectiveness* | L-2 | effectiveness* |
| 1 | Control | — | 8.44 a | — | 13.44 a | — | 7.44 a | — |
| 2 | PROLIPOSOMES | 1N | 6.06 c | 28 | 7.25 d | 46 | 2.88 b | 61 |
| | Difenoconazole | | | | | | | |
| 3 | PROLIPOSOMES | 0.8N | 7.06 bc | 16 | 8.94 bc | 33 | 5.06 ab | 32 |
| | Difenoconazole | | | | | | | |
| 4 | PROLIPOSOMES | 0.6N | 7.38 ab | 13 | 9.44 bc | 30 | 5.44 ab | 27 |
| | Difenoconazole | | | | | | | |
| 5 | PROLIPOSOMES | 0.4N | 7.88 ab | 7 | 10.00 b | 26 | 6.31 a | 15 |
| | Difenoconazole | | | | | | | |
| 6 | Dafne 250 EC | 1N | 7.31 ab | 13 | 8.25 cd | 39 | 3.69 b | 50 |

| | | | |
|---|---|---|---|
| NIR 0.05 (LSD 0.05) | 1.17 | 1.56 | 2.43 |

*effectiveness calculated using the Abbott formula
**DAA - number of days after application

TABLE 46b
The average percentage of leaf surface infestation and the effectiveness of fungicides in the protection
of winter wheat against striped septoriosis of wheat leaves - Zymoseptoria tritici SEPTTR

| | | | **DAA 49 (after first treatment) | | **DAA 49 (after first treatment) | |
|---|---|---|---|---|---|---|
| | | | **DAA 28 (after second treatment) | | **DAA 28 (after second treatment) | |
| | | | BBCH 75 | | BBCH 75 | |
| | | | % surface | | % surface | |
| | Experimental | | infestation | | infestation | |
| No. | combinations | Dose | L-4 | % effectiveness* | L-2 | % effectiveness* |
| 1 | Control | — | 29.69 a | — | 9.19 a | — |
| 2 | PROLIPOSOMES | 1N | 14.75 c | 50 | 2.75 c | 70 |
| | Difenoconazole | | | | | |
| 3 | PROLIPOSOMES | 0.8N | 16.13 c | 46 | 3.81 bc | 59 |
| | Difenoconazole | | | | | |
| 4 | PROLIPOSOMES | 0.6N | 21.00 b | 29 | 4.19 bc | 54 |
| | Difenoconazole | | | | | |
| 5 | PROLIPOSOMES | 0.4N | 22.75 b | 23 | 4.50 b | 51 |
| | Difenoconazole | | | | | |
| 6 | Dafne 250 EC | 1N | 16.75 c | 44 | 3.13 bc | 66 |

| | | |
|---|---|---|
| NIR 0.05 (LSD 0.05) | 3.84 | 3.84 |

*effectiveness calculated using the Abbott formula
**DAA - number of days after application

TABLE 47
The average percentage of leaf surface infestation and the
effectiveness of fungicides in the protection of winter wheat
against brown rust - Puccinia recondita PUCCRE

| | | | **DAA 49 (after | |
|---|---|---|---|---|
| | | | first treatment) | |
| | | | **DAA 28 (after | |
| | | | second treatment) | |
| | | | BBCH 75 | |
| | | | % surface | |
| | | | infestation | % effec- |
| No. | Experimental combinations | Dose | of L-1 | tiveness* |
| 1 | Control | — | 10.25 a | — |
| 2 | PROLIPOSOMES Difenoconazole | 1N | 1.88 c | 82 |
| 3 | PROLIPOSOMES Difenoconazole | 0.8N | 2.69 c | 74 |
| 4 | PROLIPOSOMES Difenoconazole | 0.6N | 2.81 c | 73 |
| 5 | PROLIPOSOMES Difenoconazole | 0.4N | 4.81 b | 53 |
| 6 | Dafne 250 EC | 1N | 2.19 c | 79 |

*effectiveness calculated using the Abbott formula
**DAA—number of days after application

TABLE 48
The average percentage of leaf surface infestation and the effectiveness
of fungicides in the protection of winter wheat against yellow leaf
blotch - Pyrenophora tritici-repentis PYRNTR

| | | | **DAA 49 (after | |
|---|---|---|---|---|
| | | | first treatment) | |
| | | | **DAA 28 (after | |
| | | | second treatment) | |
| | | | BBCH 75 | |
| | | | % surface | |
| | | | infestation | % effec- |
| No. | Experimental combinations | Dose | of L-1 | tiveness* |
| 1 | Control | — | 8.75 a | — |
| 2 | PROLIPOSOMES Difenoconazole | 1N | 4.06 c | 54 |
| 3 | PROLIPOSOMES Difenoconazole | 0.8N | 5.69 bc | 35 |
| 4 | PROLIPOSOMES Difenoconazole | 0.6N | 6.19 b | 29 |
| 5 | PROLIPOSOMES Difenoconazole | 0.4N | 6.44 b | 26 |
| 6 | Dafne 250 EC | 1N | 5.88 bc | 33 |

| | |
|---|---|
| NIR 0.05 (LSD 0.05) | 1.77 |

*effectiveness calculated using the Abbott formula
**DAA—number of days after application

TABLE 49
Preserved green area of winter wheat.

| | | | **DAA 49 (after |
|---|---|---|---|
| | | | first treatment) |
| | | | **DAA 28 (after |
| | | | second treatment) |
| | | | BBCH 75 |
| | | | % |
| No. | Experimental combinations | Dose | L-2, L-1 |
| 1 | Control | — | 20.00 b |
| 2 | PROLIPOSOMES Difenoconazole | 1N | 31.25 a |
| 3 | PROLIPOSOMES Difenoconazole | 0.8N | 25.00 b |
| 4 | PROLIPOSOMES Difenoconazole | 0.6N | 22.50 b |
| 5 | PROLIPOSOMES Difenoconazole | 0.4N | 22.50 b |
| 6 | Dafne 250 EC | 1N | 33.75 a |

| | |
|---|---|
| NIR 0.05 (LSD 0.05) | 4.96 |

**DAA—number of days after application

TABLE 50
Fresh mass content, grain yield, mass of a thousand grains, protein content - of winter wheat.

| | | | | | | | | | Protein % of dry | |
|---|---|---|---|---|---|---|---|---|---|---|
| | | | Fresh mass | | | | Mass of thousand | | mass | |
| | | | content | | Yield* | | grains | | % of | |
| | Experimental | | | % vs. | | % vs. | | % vs. | dry | % vs. |
| No. | combinations | Dose | kg | control | t/ha | control | g | control | mass | control |
| 1 | Control | — | 9.71 a | 100 | 6.61 a | 100 | 31.73 a | 100 | 12.78 a | 100 |
| 2 | PROLIPOSOMES | 1N | 9.94 a | 102 | 6.76 a | 102 | 32.23 a | 102 | 12.95 a | 101 |
| | Difenoconazole | | | | | | | | | |
| 3 | PROLIPOSOMES | 0.8N | 10.16 a | 105 | 6.96 a | 105 | 32.97 a | 104 | 13.07 a | 102 |
| | Difenoconazole | | | | | | | | | |
| 4 | PROLIPOSOMES | 0.6N | 10.31 a | 106 | 6.96 a | 105 | 31.19 a | 98 | 13.05 a | 102 |
| | Difenoconazole | | | | | | | | | |
| 5 | PROLIPOSOMES | 0.4N | 9.66 a | 99 | 6.51 a | 98 | 32.33 a | 102 | 13.04 a | 102 |
| | Difenoconazole | | | | | | | | | |
| 6 | Dafne 250 EC | 1N | 9.83 a | 101 | 6.68 a | 101 | 32.50 a | 102 | 12.84 a | 100 |

| | | | | |
|---|---|---|---|---|
| NIR 0.05 (LSD 0.05) | 0.76 | 0.60 | 2.14 | 1.46 |

*grain yield was recalculated to 15% humidity

### Results:

During the first application carried out in the development phase BBCH 32-33 of the arable plant, symptoms of infestation by the fungus Zymoseptoria tritici, which is the cause of striped septoriosis of wheat leaves, were observed on the lower leaves of winter wheat, Tobak variety, at a level of 3% leaf infested area. On the other hand, the infestation by Blumeria graminis—the cause of powdery mildew—was at a level of 2%. Three weeks after the first application, a second treatment was performed in the development phase BBCH 45-47 of the arable plant—at that time the plants were observed to be infested by Zymoseptoria tritici in the small control fields on the order of 8.44% on the L-4 leaf, and the plants in the small control fields were infested by Blumeria graminis on the order of 14% on the leaf L-4 and 5.13% on L-3. The effectiveness of the tested fungicides three weeks after the first application was at a level of 57-89% on L-4 and 85-93% on L-3 in the case of powdery mildew, while in the case of striped septoriosis of wheat leaves it was at a level of 7-28% (Table 45, Table 46a).

Approximately two weeks after the second application, an intensity of powdery mildew on the upper leaves of about 22% was observed on the L-3 leaf and about 7% on L-2 in the small control fields. The effectiveness of the tested fungicide, depending on the dose employed, was 47-79% on the L-3 leaf, and 62-88% on the L-2 leaf. The comparative agent inhibited the disease by 65% on the L-3 leaf and by 78% on the L-2 leaf. On the other hand, striped septoriosis of leaves occurred at an intensity of approximately 13% on the L-3 leaf and approximately 7% on the L-2 leaf in the small control fields. The effectiveness of the tested fungicide, depending on the dose employed, was 26-46% on the L-3 leaf and 15-61% on the L-2 leaf. The comparative agent inhibited disease development by 39% on the L-3 leaf and by 50% on the L-2 leaf (Table 45, Table 46a).

During the evaluation performed in the development phase BBCH 75-77 of winter wheat, Tobak variety, the occurrence of such diseases as striped septoriosis of leaves, brown rust and yellow leaf blotch was observed. Striped septoriosis occurred on the L-2 subflag leaf and the L-1 flag leaf at a level of 29.69% and 9.19%, respectively. The efficacy of the tested proliposomal agent ranged from 23 to 50% on L-2 and from 51 to 70% on L-1 (Table 46b). In turn, Puccinia recondita and Pyrenophora tritici-repentis appeared on the flag leaf at a level of 10% and 9%, respectively, in the small control fields. The effectiveness of the tested fungicide in proliposome form was 53-82% for brown rust, and 26-54% for yellow leaf blotch, depending on the dose employed. On the other hand, the comparative agent Daphne 250 EC inhibited the development of brown rust by 79%, and the development of yellow leaf blotch by 33% (Table 47, Table 48).

In the development phase BBCH 75 of plants, the green area of the subflag L-2 and the flag L-1 leaves was larger for all tested combinations compared with the control (Table 49).

Grain yield, mass of a thousand grains, and percent content of protein were on the same level for all tested experimental combinations (Table 50).

### Conclusions:

1. In the experiment conducted, no symptoms of phytotoxic action of the fungicide in proliposome form in various doses and of the standard agent Dafne 250 EC on winter wheat plants of the Tobak variety were found.
2. The tested fungicide in proliposome form in doses of 0.8 N and 1 N applied against Blumeria graminis performed better than the comparative agent Dafne 250 EC.
3. Tested proliposomes applied twice in the dose of 1 N reduced the incidence of Zymoseptoria tritici better than the standard agent Dafne 250 EC.
4. Tested proliposomes applied in the dose of 1 N inhibited the development of Puccinia recondita at the level of the comparative agent.
5. The investigated fungicide in proliposome form in doses of 0.8 N and 1 N applied against Pyrenophora tritici-repentis performed better than the comparative agent Daphne 250 EC.
6. The use of proliposomes and Dafne 250 EC on average did not affect the size and the quality (mass of a thousand grains, percent content of protein) of the yield of winter wheat, Zyta variety.

### Example 23. Biological Evaluation of the Effectiveness of Difenoconazole-Containing Proliposomes (Example 1) in the Control of Powdery Mildew (Blumeria graminis (Erysiphe graminis)), Striped Septoriosis of Wheat Leaves (Mycosphaerella graminicola (Anam. Zymoseptoria Tritici) in Winter Wheat, Opoka Variety

TABLE 51
Phytotoxicity

| | | | | | Phytotoxicity | Phytotoxicity |
|---|---|---|---|---|---|---|
| | | | | | **DAA 29 (after | **DAA A 36 (after |
| | | | | | first treatment) | first treatment) |
| | | | Phytotoxicity | Phytotoxicity | **DAA 8 (after | **DAA 15 (after |
| | | | **DAA 7 (after | **DAA 21 (after | second | second |
| | | | first treatment) | first treatment) | treatment) | treatment) |
| | Experimental | | BBCH 37 | BBCH 45 | BBCH 59 | BBCH 65 |
| No. | combinations | Dose | % | % | % | % |
| 1 | Control | — | 0 a | 0 a | 0 a | 0 a |
| 2 | PROLIPOSOMES | 1N | 0 a | 0 a | 0 a | 0 a |
| | Difenoconazole | | | | | |
| 3 | PROLIPOSOMES | 0.8N | 0 a | 0 a | 0 a | 0 a |
| | Difenoconazole | | | | | |
| 4 | PROLIPOSOMES | 0.6N | 0 a | 0 a | 0 a | 0 a |
| | Difenoconazole | | | | | |
| 5 | PROLIPOSOMES | 0.4N | 0 a | 0 a | 0 a | 0 a |
| | Difenoconazole | | | | | |
| 6 | Dafne 250 EC | 1N | 0 a | 0 a | 0 a | 0 a |

| | | | | |
|---|---|---|---|---|
| NIR 0.05 (LSD 0.05) | . | . | . | . |

control = 0
**DAA - number of days after application

TABLE 52a
The average percentage of leaf surface infestation and the effectiveness of fungicides in the protection
of winter wheat against striped septoriosis of wheat leaves - Zymoseptoria tritici SEPTTR

| | | | | | **DAA A 36 (after first | | **DAA A 36 (after first | |
|---|---|---|---|---|---|---|---|---|
| | | | | | treatment) | | treatment) | |
| | | | **DAA 21 (after first | | **DAA 15 (after second | | **DAA 15 (after second | |
| | | | treatment) | | treatment) | | treatment) | |
| | | | BBCH 47-49 | | BBCH 65 | | BBCH 65 | |
| | | | % surface | | % surface | | % surface | |
| | Experimental | | infestation | % | infestation | % | infestation | % |
| No. | combinations | Dose | of L-4 | effectiveness* | of L-3 | effectiveness* | of L-2 | effectiveness* |
| 1 | Control | — | 7.94 a | — | 14.19 a | — | 7.75 a | — |
| 2 | PROLIPOSOMES | 1N | 5.75 a | 28 | 6.06 c | 57 | 1.06 b | 86 |
| | Difenoconazole | | | | | | | |
| 3 | PROLIPOSOMES | 0.8N | 5.81 a | 27 | 6.69 c | 53 | 1.88 b | 76 |
| | Difenoconazole | | | | | | | |
| 4 | PROLIPOSOMES | 0.6N | 6.06 a | 24 | 7.19 bc | 49 | 2.00 b | 74 |
| | Difenoconazole | | | | | | | |
| 5 | PROLIPOSOMES | 0.4N | 6.63 a | 17 | 9.50 b | 33 | 3.25 b | 58 |
| | Difenoconazole | | | | | | | |
| 6 | Dafne 250 EC | 1N | 6.19 a | 22 | 6.38 c | 55 | 0.94 b | 88 |

| | | | |
|---|---|---|---|
| NIR 0.05 (LSD 0.05) | 2.13 | 2.52 | 2.16 |

*effectiveness calculated using the Abbott formula
**DAA - number of days after application

TABLE 52b
The average percentage of leaf surface infestation and the effectiveness
of fungicides in the protection of winter wheat against striped
septoriosis of wheat leaves - Zymoseptoria tritici SEPTTR

| | | | **DAA 49 (after first | | **DAA 49 (after first | |
|---|---|---|---|---|---|---|
| | | | treatment) | | treatment) | |
| | | | **DAA 28 (after second | | ** DAA 28 (after second | |
| | | | treatment) | | treatment) | |
| | | | BBCH 75 | | BBCH 75 | |
| | | | % surface | | % surface | |
| | Experimental | | infestation | % | infestation | % |
| No. | combinations | Dose | L-2 | effectiveness* | L-1 | effectiveness* |
| 1 | Control | — | 25.63 a | — | 9.88 a | — |
| 2 | PROLIPOSOMES | 1N | 11.31 c | 56 | 2.56 c | 74 |
| | Difenoconazole | | | | | |
| 3 | PROLIPOSOMES | 0.8N | 12.63 c | 51 | 4.06 bc | 59 |
| | Difenoconazole | | | | | |
| 4 | PROLIPOSOMES | 0.6N | 13.31 bc | 48 | 4.44 bc | 55 |
| | Difenoconazole | | | | | |
| 5 | PROLIPOSOMES | 0.4N | 15.38 b | 40 | 5.56 b | 44 |
| | Difenoconazole | | | | | |
| 6 | Dafne 250 EC | 1N | 11.56 c | 55 | 4.06 bc | 59 |

| | | |
|---|---|---|
| NIR 0.05 (LSD 0.05) | 2.33 | 1.98 |

*effectiveness calculated using the Abbott formula
**DAA - number of days after application

TABLE 53
Preserved green area of winter wheat.

| | | | **DAA 49 (after |
|---|---|---|---|
| | | | first treatment) |
| | | | **DAA 28 (after |
| | | | second treatment) |
| | | | BBCH 75 |
| | | | % |
| No. | Experimental combinations | Dose | L-2, L-1 |
| 1 | Control | — | 42.50 c |
| 2 | PROLIPOSOMES Difenoconazole | 1N | 60.00 b |
| 3 | PROLIPOSOMES Difenoconazole | 0.8N | 61.25 b |
| 4 | PROLIPOSOMES Difenoconazole | 0.6N | 61.25 b |
| 5 | PROLIPOSOMES Difenoconazole | 0.4N | 56.25 b |
| 6 | Dafne 250 EC | 1N | 68.75 a |

| | |
|---|---|
| NIR 0.05 (LSD 0.05) | 5.15 |

**DAA—number of days after application

TABLE 54
Fresh mass content, grain yield, mass of a thousand grains, protein content - of winter wheat.

| | | | | | | | | | Protein % of dry | |
|---|---|---|---|---|---|---|---|---|---|---|
| | | | Fresh mass | | | | Mass of thousand | | mass | |
| | | | content | | Yield* | | grains | | % of | |
| | Experimental | | | % vs. | | % vs. | | % vs. | dry | % vs. |
| No. | combinations | Dose | kg | control | t/ha | control | g | control | mass | control |
| 1 | Control | — | 12.25 b | 100 | 8.23 a | 100 | 41.01 a | 100 | 9.15 a | 100 |
| 2 | PROLIPOSOMES | 1N | 13.10 a | 107 | 8.76 a | 107 | 42.92 a | 105 | 8.86 a | 97 |
| | Difenoconazole | | | | | | | | | |
| 3 | PROLIPOSOMES | 0.8N | 13.20 a | 108 | 8.87 a | 108 | 42.34 a | 103 | 9.29 a | 102 |
| | Difenoconazole | | | | | | | | | |
| 4 | PROLIPOSOMES | 0.6N | 12.78 ab | 104 | 8.54 a | 104 | 42.52 a | 104 | 9.37 a | 102 |
| | Difenoconazole | | | | | | | | | |
| 5 | PROLIPOSOMES | 0.4N | 12.81 ab | 105 | 8.59 a | 104 | 42.58 a | 104 | 8.98 a | 98 |
| | Difenoconazole | | | | | | | | | |
| 6 | Dafne 250 EC | 1N | 13.01 a | 106 | 8.70 a | 106 | 43.26 a | 105 | 9.12 a | 100 |

| | | | | |
|---|---|---|---|---|
| NIR 0.05 (LSD 0.05) | 0.59 | 0.40 | 2.07 | 0.93 |

*grain yield was recalculated to 15% humidity

### Results:

During the first application performed in the development phase BBCH 32-33 of the arable plant, symptoms of Zymoseptoria tritici infestation, which causes striped septoriosis of wheat leaves, at a level of 2% leaf infested area, were observed on the lower leaves of winter wheat of the Opoka variety.

Three weeks after the first application, a second treatment was performed in the development phase BBCH 45 of the arable plant. At that time, the average infestation of plants by Zymoseptoria tritici on the L-4 leaf in the small control fields was about 8%.

The effectiveness of the tested fungicides three weeks after the first application was at a level of 17-28% in the case of striped septoriosis of wheat leaves (Table 52a).

Approximately two weeks after the second application, striped septoriosis was observed on the upper leaves in an intensity of about 14% on the L-3 leaf and of about 8% on the L-2 in the small control fields. The effectiveness of the tested fungicides was 33-57% on the L-3 leaf and 58-86% on the L-2 leaf. The comparative agent inhibited disease development by 55% on the L-3 leaf and by 88% on the L-2 leaf (Table 52a).

During the evaluation performed in the development phase BBCH 75 of winter wheat, Opoka variety, the occurrence of striped septoriosis of leaves on the L-2 subflag leaf and the L-1 flag leaf was observed at a level of 25.63% and 9.88%, respectively. The efficacy of the tested proliposome agent ranged from 40 to 74% for striped septoriosis of wheat leaves. The comparative agent inhibited disease development by 55% on the L-2 leaf and by 59% on the L-1 leaf (Table 52b).

In the development phase BBCH 75 of plants, the green area of the subflag L-2 and the flag L-1 leaves was higher for all tested combinations, as compared with the control (Table 53).

### Conclusions:

1. In the experiment conducted, no phytotoxic effects of the fungicide in proliposome form in various doses and of the standard agent Dafne 250 EC on winter wheat plants of the Opoka variety were found.
2. The tested fungicide in proliposome form applied twice in the dose of 1 N reduced the occurrence of Zymoseptoria tritici better than the standard agent Dafne 250 EC.
3. An increase in green leaf area (GLA) was observed after application of the studied proliposome agent at all doses tested and of the comparative agent Dafne 250 EC, as compared with the control.
4. In the small fields treated with proliposomes, irrespective of the dose employed, an increase in the yield and an increase in the mass of a thousand seeds were observed, as compared with the small control fields.

### Example 24. Biological Evaluation of the Effectiveness of the Action of Difenoconazole-Containing Proliposomes (Example 1) in Controlling Blackleg (Leptosphaeria maculans) in Winter Oilseed Rape, Architect Variety

TABLE 55
Phytotoxicity.

| | | | Phytotoxicity | | |
|---|---|---|---|---|---|
| | | | **DAA | **DAA | **DAA |
| | | | 7 | 33 | 70 |
| | Experimental | | BBCH 59 | BBCH 65-67 | BBCH 85 |
| No. | combinations | Dose | % | % | % |
| 1 | Control | — | 0 a | 0 a | 0 a |
| 2 | PROLIPOSOMES | 1N | 0 a | 0 a | 0 a |
| | Difenoconazole | | | | |
| 3 | PROLIPOSOMES | 0.8N | 0 a | 0 a | 0 a |
| | Difenoconazole | | | | |
| 4 | PROLIPOSOMES | 0.5N | 0 a | 0 a | 0 a |
| | Difenoconazole | | | | |
| 5 | PROLIPOSOMES | 0.4N | 0 a | 0 a | 0 a |
| | Difenoconazole | | | | |
| 6 | Dafne 250 EC | 1N | 0 a | 0 a | 0 a |

| | | | |
|---|---|---|---|
| NIR 0.05 (LSD 0.05) | . | . | . |

TABLE 56
The average percentage of surface infestation and fungicide
effectiveness in the protection of winter oilseed rape against
blackleg - Leptosphaeria maculans LEPTMA.

| | | | **70 DAA | |
|---|---|---|---|---|
| | | | BBCH 85 | |
| | Experimental | | % infested area | % |
| No. | combinations | Dose | of shoot | effectiveness* |
| 1 | Control | — | 26.71 a | — |
| 2 | PROLIPOSOMES | 1N | 10.56 b | 60 |
| | Difenoconazole | | | |
| 3 | PROLIPOSOMES | 0.8N | 11.82 b | 56 |
| | Difenoconazole | | | |
| 4 | PROLIPOSOMES | 0.5N | 12.43 b | 53 |
| | Difenoconazole | | | |
| 5 | PROLIPOSOMES | 0.4N | 13.08 b | 51 |
| | Difenoconazole | | | |
| 6 | Dafne 250 EC | 1N | 11.52 b | 57 |

| | |
|---|---|
| NIR 0.05 (LSD 0.05) | 4.87 |

*effectiveness calculated using the Abbott formula
**DAA— number of days after application

TABLE 57
Grain yield, mass of a thousand seeds, and oil content.

| | | | | | Mass of thousand | | Oil content | |
|---|---|---|---|---|---|---|---|---|
| | | | Yield* | | grains | | % of | |
| | Experimental | | | % vs. | | % vs. | dry | % vs. |
| No. | combinations | Dose | t/ha | control | g | control | mass | control |
| 1 | Control | — | 1.79 b | 100 | 4.59 a | 100 | 47.88 a | 100 |
| 2 | PROLIPOSOMES | 1N | 2.48 a | 139 | 4.92 a | 107 | 47.86 a | 100 |
| | Difenoconazole | | | | | | | |
| 3 | PROLIPOSOMES | 0.8N | 2.40 a | 134 | 4.72 a | 103 | 47.94 a | 100 |
| | Difenoconazole | | | | | | | |
| 4 | PROLIPOSOMES | 0.5N | 2.27 a | 127 | 4.65 a | 101 | 48.04 a | 100 |
| | Difenoconazole | | | | | | | |
| 5 | PROLIPOSOMES | 0.4N | 2.21 a | 123 | 4.61 a | 100 | 48.38 a | 101 |
| | Difenoconazole | | | | | | | |
| 6 | Dafne 250 EC | 1N | 2.33 a | 130 | 4.73 a | 103 | 48.50 a | 101 |

| | | | |
|---|---|---|---|
| NIR 0.05 (LSD 0.05) | 0.41 | 0.27 | 0.69 |

*grain yield was recalculated to 9% humidity

### Results:

The infestation of winter oilseed rape, Architect variety, by Leptosphaeria maculans assessed in the BBCH 85 phase was at an average level and reached 27% in the small control fields. Infestation by the pathogen was at the level sufficient to assess the effectiveness of the tested fungicides.

### Conclusions:

1. No phytotoxic effect on winter oilseed rape plants, Architect variety, was found both for the tested fungicide in proliposome form, regardless of the dose employed, and for the comparative agent Dafne 250 EC at the dose of 1 N.
2. The studied fungicide in proliposome form, irrespective of the dose employed, and the comparative agent Dafne 250 EC significantly inhibited the development of blackleg on winter oilseed rape plants. An increase in the effectiveness of the proliposomes with the increase in the applied dose was observed.
3. The investigated fungicide in proliposome form at the dose of 1 N applied against Leptosphaeria maculans performed better than the comparative agent Dafne 250 EC.
4. In the small fields treated with proliposomes, regardless of the dose employed, a significant increase in the yield and a moderate increase in the mass of a thousand seeds were observed in comparison with the small control fields.

### Example 25. Biological Evaluation of the Effectiveness of the Difenoconazole-Containing Proliposomes (Example 1) in the Control of Sclerotinia sclerotiorum in Winter Oilseed Rape, Architect Variety

TABLE 58
Phytotoxicity.

| | | | Phytotoxicity | | |
|---|---|---|---|---|---|
| | | | **DAA 7 | **DAA 31 | **DAA 51 |
| | | | BBCH 67 | BBCH 75 | BBCH 85 |
| No. | Experimental combinations | Dose | % | % | % |
| 1 | Control | — | 0 a | 0 a | 0 a |
| 2 | PROLIPOSOMES Difenoconazole | 1N | 0 a | 0 a | 0 a |
| 3 | PROLIPOSOMES Difenoconazole | 0.8N | 0 a | 0 a | 0 a |
| 4 | PROLIPOSOMES Difenoconazole | 0.5N | 0 a | 0 a | 0 a |
| 5 | PROLIPOSOMES Difenoconazole | 0.4N | 0 a | 0 a | 0 a |
| 6 | Dafne 250 EC | 1N | 0 a | 0 a | 0 a |

| | | | |
|---|---|---|---|
| NIR 0.05 (LSD 0.05) | . | . | . |

control = 0
**DAA—number of days after application

TABLE 59
The average percentage of surface infestation and fungicide
effectiveness in the protection of winter oilseed rape
against Sclerotinia sclerotiorum (SCLESC).

| | | | 51 **DAA | |
|---|---|---|---|---|
| | | | BBCH 85 | |
| | Experimental | | % infested area | % |
| No. | combinations | Dose | of stalk | effectiveness* |
| 1 | Control | — | 28.10 a | — |
| 2 | PROLIPOSOMES | 1N | 11.60 c | 59 |
| | Difenoconazole | | | |
| 3 | PROLIPOSOMES | 0.8N | 12.50 bc | 56 |
| | Difenoconazole | | | |
| 4 | PROLIPOSOMES | 0.5N | 13.35 bc | 52 |
| | Difenoconazole | | | |
| 5 | PROLIPOSOMES | 0.4N | 14.70 b | 48 |
| | Difenoconazole | | | |
| 6 | Dafne 250 EC | 1N | 13.10 bc | 53 |

| | |
|---|---|
| NIR 0.05 (LSD 0.05) | 2.67 |

*effectiveness calculated using the Abbott formula
**DAA—number of days after application

TABLE 60
Grain yield, mass of a thousand seeds, and oil content.

| | | | | | | | Oil content | |
|---|---|---|---|---|---|---|---|---|
| | | | Yield* | | Mass of thousand grains | | % of | |
| | Experimental | | | % vs. | | % vs. | dry | % vs. |
| No. | combinations | Dose | t/ha | control | g | control | mass | control |
| 1 | Control | — | 2.17 c | 100 | 4.32 a | 100 | 48.25 a | 100 |
| 2 | PROLIPOSOMES | 1N | 2.61 a | 120 | 4.54 a | 105 | 48.42 a | 100 |
| | Difenoconazole | | | | | | | |
| 3 | PROLIPOSOMES | 0.8N | 2.49 ab | 115 | 4.49 a | 104 | 48.47 a | 100 |
| | Difenoconazole | | | | | | | |
| 4 | PROLIPOSOMES | 0.5N | 2.37 abc | 109 | 4.46 a | 103 | 48.30 a | 100 |
| | Difenoconazole | | | | | | | |
| 5 | PROLIPOSOMES | 0.4N | 2.36 bc | 109 | 4.38 a | 101 | 48.32 a | 101 |
| | Difenoconazole | | | | | | | |
| 6 | Dafne 250 EC | 1N | 2.45 ab | 113 | 4.64 a | 107 | 48.32 a | 100 |

| | | | |
|---|---|---|---|
| NIR 0.05 (LSD 0.05) | 0.23 | 0.60 | 0.42 |

*grain yield was recalculated to 9% humidity

### Results:

The first symptoms of infestation by Sclerotinia sclerotiorum were observed in the BBCH 75 phase. Infestation of winter oilseed rape plants, Architect variety, by Sclerotinia sclerotiorum, assessed in the BBCH 85 phase, was moderate and reached 28% in the small control fields. Infestation by the pathogen was at the level sufficient to assess the effectiveness of the tested fungicides.

### Conclusions:

1. No phytotoxic effect on winter oilseed rape plants of the Architect variety was observed both for the tested in proliposome form, regardless of the dose employed, and for the comparison agent Dafne 250 EC at the dose of 1 N.
2. The investigated fungicide in proliposome form, irrespective of the dose employed, and the comparative agent Dafne 250 EC significantly inhibited the development of Sclerotinia sclerotiorum on winter oilseed rape plants. An increase in the effectiveness of the proliposomes with the increase in the applied dose was observed.
3. The investigated fungicide in proliposome form used against Sclerotinia sclerotiorum in doses of 0.8 N and 1 N performed better than the comparative agent Dafne 250 EC. The results obtained demonstrate the possibility of a two-fold dose reduction preserving an effectiveness of the proliposome composition at the dose of 0.5 N comparable with the comparative agent Dafne 250 EC at the dose of 1 N.
4. In the small fields treated with proliposomes, irrespective of the dose employed, an increase in the yield, an increase in the mass of a thousand seeds were observed, as compared with the small control fields.

### Example 26. Biological Evaluation of the Efficacy of Difenoconazole-Containing Proliposomes (Example 1) in the Control of Sclerotinia sclerotiorum in Winter Oilseed Rape, Visby Variety

TABLE 61
Phytotoxicity.

| | | | Phytotoxicity | | |
|---|---|---|---|---|---|
| | | | **DAA | **DAA | **DAA |
| | | | 7 | 32 | 52 |
| | Experimental | | BBCH 67 | BBCH 75 | BBCH 85 |
| No. | combinations | Dose | % | % | % |
| 1 | Control | — | 0 a | 0 a | 0 a |
| 2 | PROLIPOSOMES | 1N | 0 a | 0 a | 0 a |
| | Difenoconazole | | | | |
| 3 | PROLIPOSOMES | 0.8N | 0 a | 0 a | 0 a |
| | Difenoconazole | | | | |
| 4 | PROLIPOSOMES | 0.5N | 0 a | 0 a | 0 a |
| | Difenoconazole | | | | |
| 5 | PROLIPOSOMES | 0.4N | 0 a | 0 a | 0 a |
| | Difenoconazole | | | | |
| 6 | Dafne 250 EC | 1N | 0 a | 0 a | 0 a |

| | | | |
|---|---|---|---|
| NIR 0.05 (LSD 0.05) | . | . | . |

control = 0
**DAA—number of days after application

TABLE 62
The average percentage of surface infestation and fungicide
effectiveness in the protection of winter oilseed rape
against Sclerotinia sclerotiorum (SCLESC).

| | | | 52 **DAA | |
|---|---|---|---|---|
| | | | BBCH 85 | |
| | Experimental | | % infested area | % |
| No. | combinations | Dose | of stalk | effectiveness* |
| 1 | Control | — | 27.75 a | — |
| 2 | PROLIPOSOMES | 1N | 9.90 c | 64 |
| | Difenoconazole | | | |
| 3 | PROLIPOSOMES | 0.8N | 11.70 bc | 58 |
| | Difenoconazole | | | |
| 4 | PROLIPOSOMES | 0.5N | 11.85 bc | 57 |
| | Difenoconazole | | | |
| 5 | PROLIPOSOMES | 0.4N | 13.76 b | 50 |
| | Difenoconazole | | | |
| 6 | Dafne 250 EC | 1N | 15.10 b | 46 |

| | |
|---|---|
| NIR 0.05 (LSD 0.05) | 3.33 |

*effectiveness calculated using the Abbott formula
**DAA—number of days after application

TABLE 63
Grain yield, mass of a thousand seeds, and oil content.

| | | | | | | | Oil content | |
|---|---|---|---|---|---|---|---|---|
| | | | Yield* | | Mass of thousand grains | | % of | |
| | Experimental | | | % vs. | | % vs. | dry | % vs. |
| No. | combinations | Dose | t/ha | control | g | control | mass | control |
| 1 | Control | — | 3.28 a | 100 | 5.27 a | 100 | 47.45 a | 100 |
| 2 | PROLIPOSOMES | 1N | 3.57 a | 109 | 5.49 a | 104 | 47.44 a | 100 |
| | Difenoconazole | | | | | | | |
| 3 | PROLIPOSOMES | 0.8N | 3.40 a | 104 | 5.47 a | 104 | 47.75 a | 101 |
| | Difenoconazole | | | | | | | |
| 4 | PROLIPOSOMES | 0.5N | 3.32 a | 101 | 5.45 a | 103 | 47.85 a | 101 |
| | Difenoconazole | | | | | | | |
| 5 | PROLIPOSOMES | 0.4N | 3.30 a | 101 | 5.37 a | 102 | 47.80 a | 101 |
| | Difenoconazole | | | | | | | |
| 6 | Dafne 250 EC | 1N | 3.40 a | 104 | 5.36 a | 102 | 47.24 a | 100 |

| | | | |
|---|---|---|---|
| NIR 0.05 (LSD 0.05) | 0.30 | 0.20 | 0.42 |

*grain yield was recalculated to 9% humidity

### Results:

The first symptoms of infestation by Sclerotinia sclerotiorum were observed in the BBCH 75 phase. Infestation of winter oilseed rape plants, Visby variety, assessed in the BBCH 85 phase was moderate and reached 28% in the small control fields. Infestation by the pathogen was at the level sufficient to assess the effectiveness of the tested fungicides.

### Conclusions:

1. No phytotoxic effect on the winter oilseed rape plant, Visby variety, was found both for the tested fungicide in proliposome form, regardless of the dose employed, and for the comparison agent Dafne 250 EC in the dose of 1 N.
2. The investigated fungicide in proliposome form, irrespective of the dose employed, and the comparative agent Dafne 250 EC significantly inhibited the development of Sclerotinia sclerotiorum on winter oilseed rape plants. An increase in the effectiveness of the proliposomes with the increase in the applied dose was observed.
3. The investigated fungicide in proliposome form at all doses tested applied against Sclerotinia sclerotiorum performed better than the comparative agent Dafne 250 EC. The results obtained demonstrate the possibility of reducing the dose by 60% while maintaining the same effectiveness of the proliposome composition as that of the comparison agent Dafne 250 EC.
4. In the small fields treated with proliposomes, irrespective of the dose employed, an increase in the yield and an increase in the mass of a thousand seeds were observed, as compared with the small control fields.

### Example 27. Biological Evaluation of the Effectiveness of Difenoconazole-Containing Proliposomes (Example 1) in the Control of Sclerotinia sclerotiorum in Winter Oilseed Rape, Alibaba Variety

TABLE 64
Phytotoxicity.

| | | | Phytotoxicity | | |
|---|---|---|---|---|---|
| | | | **DAA 7 | **DAA 31 | **DAA 51 |
| | | | BBCH 67 | BBCH 75 | BBCH 85 |
| No. | Experimental combinations | Dose | % | % | % |
| 1 | Control | — | 0 a | 0 a | 0 a |
| 2 | PROLIPOSOMES Difenoconazole | 1N | 0 a | 0 a | 0 a |
| 3 | PROLIPOSOMES Difenoconazole | 0.8N | 0 a | 0 a | 0 a |
| 4 | PROLIPOSOMES Difenoconazole | 0.5N | 0 a | 0 a | 0 a |
| 5 | PROLIPOSOMES Difenoconazole | 0.4N | 0 a | 0 a | 0 a |
| 6 | Dafne 250 EC | 1N | 0 a | 0 a | 0 a |

| | | | |
|---|---|---|---|
| NIR 0.05 (LSD 0.05) | . | . | . |

control = 0
**DAA—number of days after application

TABLE 65
The average percentage of surface infestation and the effectiveness
of fungicides in the protection of winter oilseed rape against
Sclerotinia sclerotiorum SCLESC.

| | | | **DAA 52 | |
|---|---|---|---|---|
| | | | BBCH 85 | |
| | Experimental | | % infested area | % |
| No. | combinations | Dose | of stalk | effectiveness* |
| 1 | Control | — | 28.90 a | — |
| 2 | PROLIPOSOMES | 1N | 11.96 b | 59 |
| | Difenoconazole | | | |
| 3 | PROLIPOSOMES | 0.8N | 13.90 b | 52 |
| | Difenoconazole | | | |
| 4 | PROLIPOSOMES | 0.5N | 14.40 b | 50 |
| | Difenoconazole | | | |
| 5 | PROLIPOSOMES | 0.4N | 17.15 b | 41 |
| | Difenoconazole | | | |
| 6 | Dafne 250 EC | 1N | 16.20 b | 44 |

| | |
|---|---|
| NIR 0.05 (LSD 0.05) | 4.97 |

*effectiveness calculated using the Abbott formula
**DAA—number of days after application

TABLE 66
Grain yield, mass of a thousand seeds, and oil content.

| | | | | | | | Oil content | |
|---|---|---|---|---|---|---|---|---|
| | | | Yield* | | Mass of thousand grains | | % of | |
| | Experimental | | | % vs. | | % vs. | dry | % vs. |
| No. | combinations | Dose | t/ha | control | g | control | mass | control |
| 1 | Control | — | 3.78 b | 100 | 4.76 a | 100 | 48.42 a | 100 |
| 2 | PROLIPOSOMES | 1 N | 4.27 a | 113 | 4.84 a | 102 | 48.37 a | 100 |
| | Difenoconazole | | | | | | | |
| 3 | PROLIPOSOMES | 0.8 N | 4.21 a | 111 | 4.87 a | 102 | 48.48 a | 100 |
| | Difenoconazole | | | | | | | |
| 4 | PROLIPOSOMES | 0.5 N | 4.14 a | 110 | 4.70 a | 99 | 47.52 a | 98 |
| | Difenoconazole | | | | | | | |
| 5 | PROLIPOSOMES | 0.4 N | 4.13 a | 109 | 4.44 a | 93 | 48.11 a | 99 |
| | Difenoconazole | | | | | | | |
| 6 | Dafne 250 EC | 1 N | 4.14 a | 110 | 4.83 a | 101 | 48.55 a | 100 |

| | | | |
|---|---|---|---|
| NIR 0.05 (LSD 0.05) | 0.19 | 0.36 | 1.48 |

*grain yield was recalculated to 9% humidity

### Results:

The first symptoms of infestation by Sclerotinia sclerotiorum were observed in the BBCH 75 phase. Infestation of winter oilseed rape plants, Alibaba variety, by Sclerotinia sclerotiorum assessed in the BBCH 85 phase was moderate and reached 29% in the small control fields. Infestation by the pathogen was at the level sufficient to assess the effectiveness of the tested fungicides.

### Conclusions:

1. No phytotoxic effect on winter oilseed rape, Alibaba variety, was found both for the tested fungicide in proliposome form, regardless of the dose employed, and for the comparative agent Dafne 250 EC at the dose of 1 N.
2. The investigated proliposomes, irrespective of the dose employed, and the comparative agent Dafne 250 EC significantly inhibited the development of Sclerotinia sclerotiorum on winter oilseed rape plants. An increase in the effectiveness of the proliposomes with the increase in the applied dose was observed.
3. The investigated fungicide in proliposome form in doses of 0.5 N, 0.8 N and 1 N applied against Sclerotinia sclerotiorum performed better than the comparative agent Dafne 250 EC. The results obtained demonstrate the possibility of a two-fold dose reduction while maintaining the same effectiveness of the proliposome composition as in the case of the comparative agent Dafne 250 EC.
4. The use of proliposomes and Dafne 250 EC on average did not affect the size and the quality (mass of a thousand grains, percent oil content) of the yield of winter oilseed rape, Alibaba variety.

1. A liquid proliposome composition of plant protection agents comprising at least one plant protection agent, at least one phospholipid and at least one organic solvent, wherein:
at least one plant protection agent is present in an amount from 1% to 50% by weight,
at least one phospholipid is lecithin and is present in an amount from 20% to 75% by weight,
at least one organic solvent is selected from a group consisting of ethers, glycol ethers, n-butylpyrrolidone, ethylene glycol monobutyl ether, propylene carbonate, N,N-dimethyllactamide, 5-dimethylamino-2-methyl-5-oxovaleric acid methyl ester and present from 20% to 75% by weight,
and the composition further includes:
from 0.1% to 35% by weight of at least one agrochemically acceptable auxiliary substance, including at least one surfactant selected from the group consisting of polysorbate 20, a mixture of long-chain (C12-15) fatty alcohols ethoxylated with 3-5 molecules of ethylene oxide, and octylamine in an amount of less than 15% by weight,
from 0 to 12% by weight of water or an aqueous solution of an agrochemically acceptable salt or a buffer substance.

2. The composition according to claim 1, wherein the at least one plant protection agent is a herbicide or a fungicide.

3. The composition according to claim 1, wherein the at least one plant protection agent constitutes from 5% to 20% by weight of the composition.

4. The composition according to claim 1, wherein the ratio of at least one phospholipid to at least one plant protection agent is from 25:1 to 2:1.

5. The composition according to claim 1, wherein at least one phospholipid comprises from 5% to 99.99% of phosphatidylcholine.

6. (canceled)

7. The composition according to claim 1, wherein at least one phospholipid constitutes from 20% to 45% by weight of the composition.

8. The composition according to claim 1, wherein the at least one surfactant constitutes 3% by weight based on the weight of the composition.

9-10. (canceled)

11. The composition according to claim 1, wherein, in addition to the at least one surfactant, the composition comprises at least one other auxiliary substance selected from the group comprising antifoaming agents, antioxidants, and biodegradable, non-volatile and non-flammable agents affecting the fluidity of the lipid film.

12. The composition according to claim 1, characterized in that wherein at least one organic solvent constitutes from 20% to 30% by weight of the composition.

13. (canceled)

14. The composition according to claim 1, wherein the composition comprises 8% by weight of water or an aqueous solution of the agrochemically acceptable salt or a buffer substance.

15. A process for the preparation of a composition according to claim 1 comprising, in sequence:
a) mixing at least one phospholipid in an amount from 20% to 75% by weight in at least one organic solvent in an amount from 20% to 75% by weight of the final composition to obtain a mixture,
b) adding at least one surfactant selected from the group consisting of polysorbate 20, a mixture of long-chain (C12-15) fatty alcohols ethoxylated with 3-5 molecules of ethylene oxide, and octylamine in an amount of less than 15% by weight of the final composition to the mixture resulting from step a) while continuing mixing,
c) adding at least one plant protection agent in an amount from 1% to 50% by weight of the final composition to the mixture resulting from step b) while continuing mixing,
d) optionally adding water or an aqueous solution of a salt or an agrochemically acceptable buffer substance in an amount from 0 to 12% by weight of the final composition to the mixture resulting from step c),
e) optionally adding to the mixture resulting from step c) or d) at least one agrochemically acceptable auxiliary substance in an amount such that, including the surfactant added in step b), the at least one agrochemically acceptable auxiliary substance and the surfactant constitute from 0.1% to 35% by weight of the final composition defined in claim 1,
f) the mixture obtained in step e) is mixed to form the final proliposome composition.
